(19) United States
(12) Patent Application Publication
(10) Pub. No.: US 2006/0085469 A1
(43) Pub. Date: Apr. 20, 2006

(54) System and method for rules based content mining, analysis and implementation of consequences

(76) Inventors: Paul Douglass Pfeiffer, Manassas, VA (US); Miguel Angel Perez, Vienna, VA (US); Christopher M. Taylor, Sterling, VA (US); Diane V. Childers, Woodbridge, VA (US); Amy Y. Lee, South Riding, VA (US); Damien L. Giese, Centreville, VA (US); Richard K. Oprendek, Gainesville, VA (US)

Correspondence Address: ANDREWS KURTH LLP, 1350 I STREET, N.W., SUITE 1100, WASHINGTON, DC, 20005, US

(21) Appl. No.: 10/933,320

(22) Filed: Sep. 3, 2004

(51) Int. Cl. G06F 17/00

(52) U.S. Cl. 707/102

(57) ABSTRACT

A system, and corresponding methods are disclosed for automated rule based content mining, analysis, and implementation of consequences to input data. The methods for automated rule based content mining, analysis and implementation of consequences to the input data include (1) providing a user interface capable of receiving user information, including information for identifying the user and their particular roles for interaction with the system; (2) providing a linked user interface that facilitates: (a) selecting a rule set or sets to use for processing with the input data, (b) selecting input data to be processed for content mining, (c) operator/reviewer verifications and/or modification of the system's analysis of the content mining, (d) applying the consequence of the analysis to the output (e) options for how to handle the final output; (3) providing a computer system for operating the system and methods for automated rule based content mining, analysis and implementation of consequences, wherein the computer system includes computer memory and a computer processor, (4) providing a hosted electronic environment operably linked to the computer system; (5) displaying the user interface on the hosted electronic environment; (6) receiving user information by way of the user interface; and (7) processing the user information with the input data to generate an audit report for each data set submitted for processing.

### TECHNICAL FIELD

The technical field is content mining of data based on prescribed rules, the analysis method of the mined content, and the implementation of consequences based on the result of the analysis of the mined content.

### BACKGROUND

Content mining is the process of examining a large set of data to identify trends in particular parameters or to discover new relationships between parameters. Content mining also involves the development of tools that analyze large sets of data to extract useful information from them. As an implementation of content mining, customer purchasing patterns may be derived from a large customer transaction database by analyzing its transaction records. Such purchasing habits can provide invaluable marketing information. For example, retailers can create more effective store displays and more effective control inventory than otherwise would be possible if they know consumer purchase patterns. As a further example, catalog companies can conduct more effective mass mailings if they know that, given that a consumer has purchased a first item, the same consumer can be expected, with some degree of probability, to purchase a particular second item within a particular time period after the first purchase.

Data mining is not to be confused with content mining, which relies on the content of the data without searching for patterns, but merely for the presence of the content. Data mining can be performed using manual or automatic processes. Current data mining systems and methods typically yield only identification or labeling of the specific data searched for. In these systems, the individual performing the data mining must manually act upon the data to further use the retrieved data, based on a set of data processing standards or rules.

Automated “content mining,” based on a set of rules and able to effect a decision based on findings, can be used in a wide range of problems. Typically automated content mining uses tools to sort the extracted data into meaningful sets or categories. With current technology generating more and more data, being able to mine not only the data, but also the content, in terms of inferential relationships of the data, and to carry out actions based on that content in an automated way is becoming more important every day. A specific example of where this methodology could be of exceptional use is in the mandated classification management of U.S government data, as specified in Executive Order 12958.

The classification management of information can be used as an illustration of content mining. Classification management includes the methodologies, processes and systems employed to manage and disseminate information based on specific guidance or rules governing how their content must be handled in terms of national security policies or private sector company/corporate level policies. By applying classification management to a collection of data, the content of said data can be analyzed, categorized, manipulated, sorted, or otherwise handled.

As part of its classification management program, the U.S. government requires that documents are marked by portions, commonly referred to as “portion marking,” where each portion receives a marking to reflect the classification of that particular portion of the document along with appropriate access and handling caveats of the data present in said portion under scrutiny. Currently, U.S. government document authors are required to read and review the content of a document, understand the significance of the content and its sensitivity, and finally manually mark each portion appropriately according to an established marking standard. This process is very time consuming, prone to disparities due to the subjective nature of the reviewer, and often plagued with errors, due to the vastness of information that must be taken into account to complete the process successfully.

### SUMMARY

What is disclosed are systems and methods for automated rule based content mining, analysis and implementation of consequences to the input data. The methods for automated rule based content mining, analysis and implementation of consequences to the input data include (1) providing a user interface capable of receiving user information, including information for identifying the user and their particular roles for interaction with the system; (2) providing a linked user interface that facilitates: (a) selecting a rule set or sets to use for processing with the input data, (b) selecting input data to be processed for content mining, (c) operator/reviewer verifications and/or modification of the system's analysis of the content mining, (d) applying the consequence of the analysis to the output (e) options for how to handle the final output; (3) providing a computer system for operating the system and methods for automated rule based content mining, analysis and implementation of consequences, wherein the computer system includes computer memory and a computer processor, (4) providing a hosted electronic environment operably linked to the computer system; (5) displaying the user interface on the hosted electronic environment; (6) receiving user information by way of the user interface; and (7) processing the user information with the input data to generate an audit report for each data set submitted for processing.

Also disclosed is a portion marking and verification tool (PMVT) for annotating portions of an original document according to a set of analysis rules. The PMVT includes an analysis engine that loads an analysis rule set according to an original document to be portion marked, divides the document into portions according to document division rules, searches the portions according to analysis rules, and applies consequences to the document portions. The PMVT also includes a review/modify module that allows for review, modification, and acceptance of the consequences and an action engine that marks one or more document portions based on the output of the review/modify module.

Further, what is disclosed is a method for portion marking an original document according to a set of analysis rules. The method includes the steps of selecting an analysis rule set for marking the original document, searching the original document for occurrences of words, phrases, numbers, etc., and/or relationships among said items. The search in the original document comprises one or more portions, and the search is first completed for each document portion, the marking occurring automatically on the document portions based on results of the search, where the marking is first completed on one document portion, and the markings of lower hierarchical level document portions are aggregated to a next higher hierarchical level document portion.

### DESCRIPTION OF THE DRAWINGS

The detailed description will refer to the following drawings in which like numerals refer to like items, and in which:

FIG. 1 is a block diagram of an environment in which a content mining system operates to mine content, analyze the mined content and apply consequences based on the analysis;

FIG. 2 illustrates implementation of rule sets to the content mining system of FIG. 1;

FIG. 3 is a block diagram of an embodiment of the content mining system of FIG. 1;

FIG. 4 illustrates an embodiment of a rules hierarchy showing various items that comprise a content mining analysis rule set;

FIG. 5 illustrates a network in which an automated portion marking and verification tool (PMVT) is used for classification management of a document;

FIG. 6 is a block diagram of an embodiment of the portion marking and verification tool;

FIG. 7 illustrates a fragment of an exemplary analysis rule set as an embodiment of portion marking rules used by the portion marking and verification tool of FIG. 6;

FIGS. 8A-8Q illustrate implementation of portion marking rules to a document; and

FIGS. 9A and 9B are flowcharts illustrating an operation of the portion marking and verification tool of FIG. 6.

### DETAILED DESCRIPTION

Described herein are systems and methods for automating the process of content mining and analysis, and applying consequences to the analyzed content. In the detailed description of the systems and methods, the following terms should be understood to have the following meanings:

As used herein, the term “intermediary service provider” refers to an agent providing a forum for users to interact with the system. For example, an intermediary service provider may provide a forum for standards and rules to be viewed and commented upon, data to be submitted to the system, users to interact with the system, outputs to be stored or disseminated, and audit reports to be stored, viewed or disseminated. In some embodiments, the intermediary service provider is a hosted electronic environment located on a network such as the Internet or World Wide Web.

As used herein, the term “link” refers to a navigational link from one document to another, or from one portion (or component) of a document to another. Typically, a link is displayed as a highlighted or underlined word or phrase, or as an icon, that can be selected by clicking on it using a mouse to move to the associated page, document or documented portion.

As used herein, the term “intranet” refers to a collection of interconnected private networks that are linked together by a set of standard protocols (such as TCP/IP and HTTP) to form a limited access, distributed network. While this term is intended to refer to what is now commonly known as intranet(s), it is also intended to encompass variations which may be made in the future, including changes and additions to existing standard protocols.

As used herein, the term “Internet” refers to a collection of interconnected (public and/or private) networks that are linked together by a set of standard protocols (such as TCP/IP and HTTP) to form a global, distributed network. While this term is intended to refer to what is now commonly known as the Internet, it is also intended to encompass variations which may be made in the future, including changes and additions to existing standard protocols.

As used herein, the terms “World Wide Web” or “Web” refer generally to both (i) a distributed collection of interlinked, user-viewable hypertext documents (commonly referred to as Web documents or Web pages) that are accessible via the Internet, and (ii) the client and server software components which provide user access to such documents using standardized Internet protocols. Currently, the primary standard protocol for allowing implementation to locate and acquire Web documents is HTTP, and the Web pages are encoded using HTML. However, the terms “Web” and “World Wide Web” are intended to encompass future markup languages and transport protocols which may be used in place of (or in addition to) HTML and HTTP.

As used herein, the term “Web site” refers to a computer system that serves informational content over a network using the standard protocols of the World Wide Web. Typically, a Web site corresponds to a particular Internet domain name, such as “proveit.net/” and includes the content associated with a particular organization. As used herein, the term is generally intended to encompass both (i) the hardware/software server components that serve the informational content over the network, and (ii) the “back end” hardware/software components, including any non-standard or specialized components, that interact with the server components to perform services for Web site users.

As used herein, the term “client-server” refers to a model of interaction in a distributed system in which a program at one site sends a request to a program at another site and waits for a response. The requesting program is called the “client,” and the program which responds to the request is called the “server.” In the context of the World Wide Web (discussed below), the client is a “Web browser” (or simply “browser”) which runs on a computer of a user; the program which responds to browser requests by serving Web pages is commonly referred to as a “Web server.”

As used herein, the term “HTML” refers to HyperText Markup Language which is a standard coding convention and set of codes for attaching presentation and linking attributes to informational content within documents. During a document authoring stage, the HTML codes (referred to as “tags”) are embedded within the informational content of the document. When the Web document (or HTML document) is subsequently transferred from a Web server to a browser, the codes are interpreted by the browser and used to parse and display the document. Additionally in specifying how the Web browser is to display the document, HTML tags can be used to create links to other Web documents (commonly referred to as “hyperlinks”).

As used herein, the term “HTTP” refers to HyperText Transport Protocol which is the standard World Wide Web client-server protocol used for the exchange of information (such as HTML documents, and client requests for such documents) between a browser and a Web server. HTTP includes a number of different types of messages which can be sent from the client to the server to request different types of server actions. For example, a “GET” message, which has the format GET, causes the server to return the document or file located at the specified URL.

As used herein, the terms “computer memory” and “computer memory device” refer to any storage media readable by a computer processor. Examples of computer memory include, but are not limited to, RAM, ROM, computer chips, digital video disc (DVDs), compact discs (CDs), hard disk drives (HDD), and magnetic tape.

As used herein, the term “computer readable medium” refers to any device or system for storing and providing information (e.g. data and instructions) to a computer processor. Examples of computer readable media include, but are not limited to, DVDs, CDs, hard disk drives, magnetic tape and servers for streaming media over networks.

As used herein, the terms “computer processor” and “central processing unit” or “CPU” and “processor” are used interchangeably and refers to one or more devices that is/are able to read a program from a computer memory (e.g., ROM, RAM or other computer memory) and perform a set of steps according to the program.

As used herein, the term “hosted electronic environment” refers to an electronic communication network accessible by computer for transferring information. One example includes, but is not limited to, a web site located on the World Wide Web.

As used herein, the term “Standards Authority” refers to an agent or entity that creates, authorizes, and/or maintains standards, from which analysis, division and/or action rules can be derived.

As used herein, the term “Standards Expert” refers to an agent or entity that has an in-depth working knowledge of the above mentioned standards.

As used herein, the term “Operator” refers to an agent that utilizes the present invention.

As used herein, the term “Reviewer” refers to an agent that reviews and authorizes actions to be taken based upon the consequences found during data analysis. In some embodiments, the operator and the reviewer can be the same entity.

As used herein, the term “Data” refers to information represented in a form suitable for processing by a computer, i.e., digital information.

As used herein, the term “Rule” refers to a set of one or more Criteria, which, if satisfied by the given Data, imply that a set of one or more Consequences apply said Data.

As used herein, the term “Criteria” refers to a set of testable conditions which, if satisfied, indicate that the Criteria has been satisfied and that its associated Rule is applicable to the considered Data.

As used herein, the term “Consequence” refers to an indicator that some action should occur if the Criteria of its associated Rule are satisfied.

As used herein, the term “Analysis Rule” refers to a Rule for associating Consequences to Data.

As used herein, the term “Division Rule” refers to a Rule for logically dividing Data into one or more sections to which Analysis Rules may be applied.

As used herein, the term “Action Rule” refers to a Rule for taking action based upon the Consequence or Consequences (if any) associated with Data based upon the application of one or more Analysis Rules.

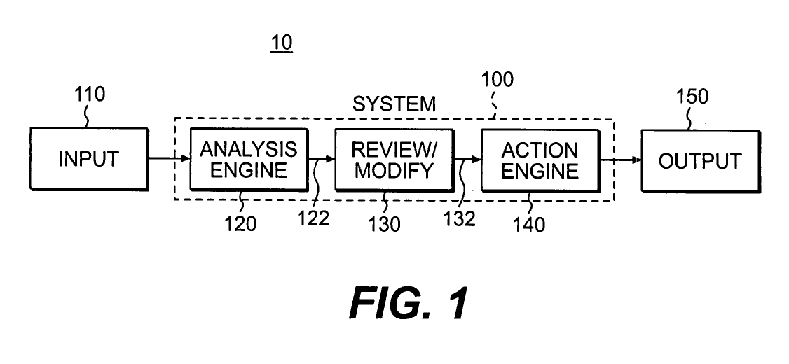

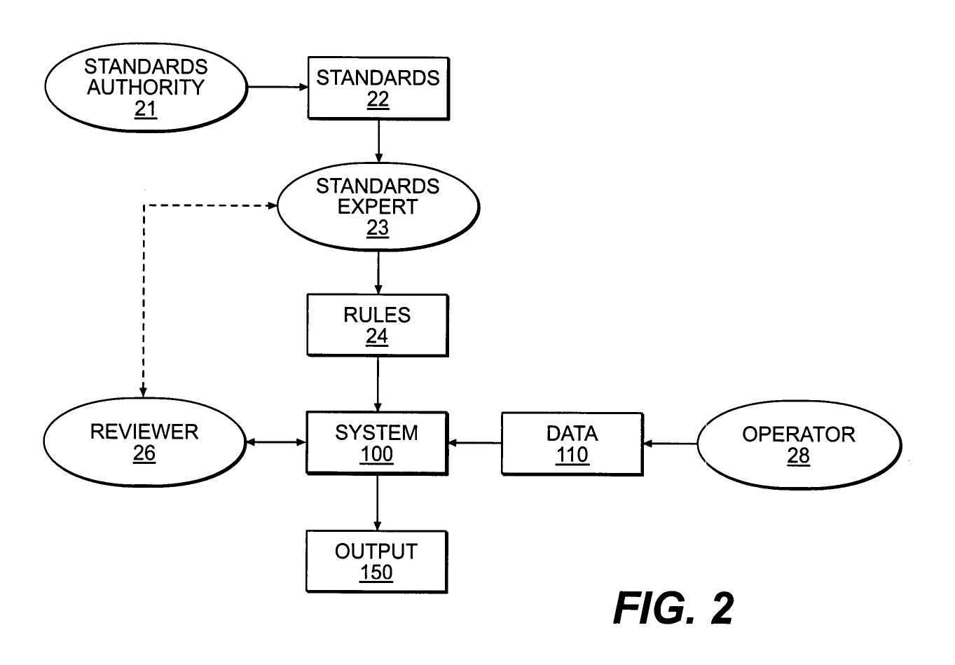

FIG. 1 is a block diagram of an environment 10 in which a content mining system 100 receives inputs 110 and produces outputs 150. The inputs 110 may include data from any number of sources, as will be described in more detail with reference to FIG. 2.

The content mining system 100 includes an analysis engine 120, a review/modify module 130, and an action engine 140. The analysis engine 120 determines which Rules apply to the inputs 110. The analysis engine 120 also determines any Consequences that are implied by the Rules. An output 122 of the analysis engine 120 is passed to the review/modify module 130, where the output 122 may be adjusted, if appropriate. An output 132 of the review/modify module 130 is then passed to the action engine 140, where an appropriate action or actions (if any) are carried out based on the output 132, thereby producing the output 150.

FIG. 2 illustrates application of rule sets to the content mining system of FIG. 1. The content mining system 100 may require inputs and interactions from several external sources. A Standards Authority 21 creates and publishes a set of Standards 22 that may be applied in general practice, with (or without) the aid of the content mining system 100. The Standards 22 may express or imply one or more Conditions and Consequences.

A Standards Expert 23 may then create Rule Set(s) based upon the Standards 22. The Rule Set(s) includes a set of discrete Rules 24 that embody expressed or implied Conditions and Consequences specified in the Standards 22. The Rules 24 may also include exceptions. The Rule Set(s) may be made in such a way as to give the content mining system 100 sufficient instruction as to how to analyze and process appropriate input data 100.

The input data 110 is supplied by Operator 28. The Operator 28 selects input data 110 that is appropriate for the content mining system 100. Once the content mining system 100 has analyzed the input data 110, Reviewer 26 interacts with the content mining system 100 in order to ensure correct application of the Rules 24 and to apply any exceptions. The Reviewer 26 also may interact with the Standards Expert 23 in order to modify the involved Rule Set(s). Once the analysis results have been reviewed, the content mining system 100 processes the Consequences determined by the analysis and produces the output 150.

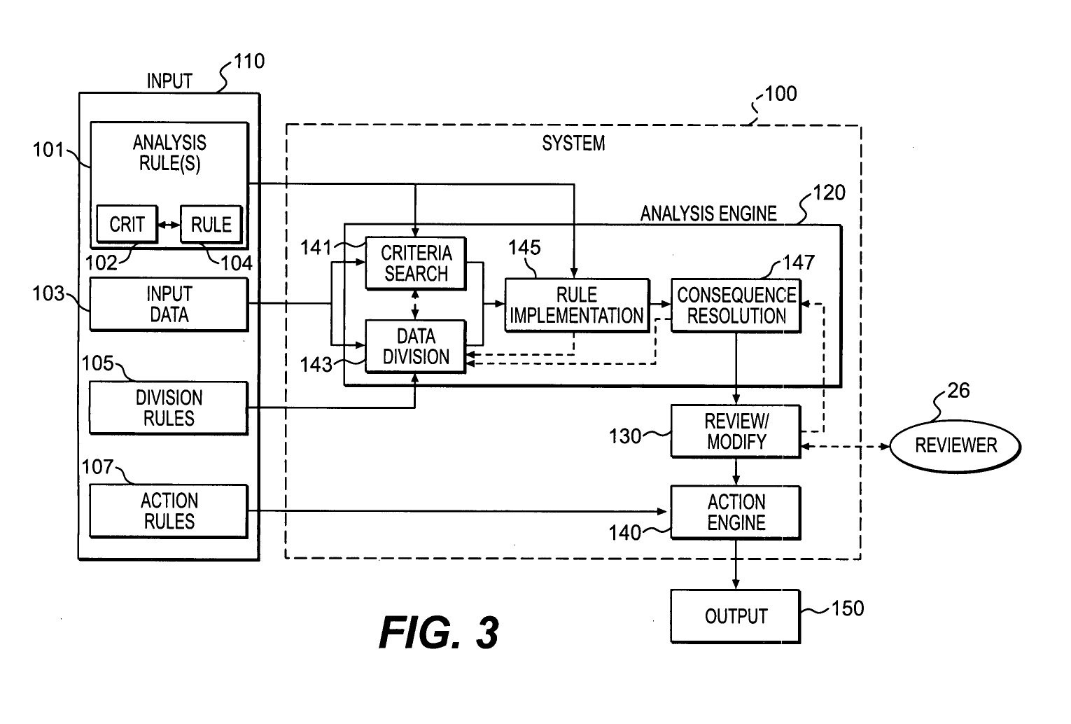

FIG. 3 illustrates a further block diagram of the content mining system 100. In FIG. 3, the input 110 is shown to include four elements: one or more Analysis Rules 101, one or more Division Rules 105, one or more Action Rules 107, and the Input Data 103. The Analysis Rules 101 include Criteria 102 and Rules 104.

The analysis engine 120 includes four modules: a criteria search module 141, a data division module 143, a rule implementation module 145, and a consequence resolution module 147.

The criteria search module 141 searches the supplied Input Data 103 for one or more elements of the components of the Criteria 102 found in the Rules 104 in the supplied Analysis Rules 101.

The data division module 143 logically divides the Input Data 103 into one or more sections based upon the Division Rules 105. The sections may be of one or more types specified by the Division Rules 105 and can relate to the Analysis Rules 101, which then may apply to a given section.

The data division module 143 and the criteria search module 141 may operate on the Input Data 103 in a serial manner or in a parallel manner. The modules 141 and 143 also may alternate processing of the Input Data 103 so long as the associated output of both processes for any discrete section is passed to the rule implementation module 145.

The rule implementation module 145 determines which Analysis Rules 101, if any, apply to a given section. The output of the criteria search module 141 is used to determine which section-appropriate Rules' Criteria have been satisfied, and consequently, which Analysis Rules 101 apply to the section. The Consequence or Consequences associated with each applicable Rule 104 are then associated with the given section. If the data division module 143 and the criteria search module 141 alternate processing, and the entirety of the Input Data 103 has not yet been processed, control may return to the data division module 143 for further processing.

The consequence resolution module 147 resolves conflicts in the set of Consequences associated with each section. Conflicts may include precedence issues, Consequences that are mutually exclusive, or Consequences that have an unfulfilled prerequisite. If the data division module 143 and the criteria search module 141 alternate processing, and the entirety of the Input Data 103 has not yet been processed, control may return to the data division module 143 for further processing.

Once the initial set of Consequences has been determined for each section, the associated sections and their Consequences are passed to the review/modify module 1310. The Reviewer 26 interacts with the compiled results in the review/modify module 130 in order to ensure the correct (intended) implementation of the Rules 104 and to apply any exceptions. Any addition, deletion, or modification due to the incorrect implementation of the Rules 104 may be communicated to the Standards Expert 23 (see FIG. 2), by either the Reviewer 26 and/or the System 100, so that the Rule's Criteria 102 can be modified to resolve the issue in the future. Any addition, deletion, or modification for any reason may require that the section be reevaluated by the consequence resolution module 147 to ensure compliance with the Standards 22 (see FIG. 2).

The action engine 140 performs any appropriate post-analysis processing. Actions may include, but are not limited to, deletion or modification of the Input Data 103, creation of an analysis report, or routing of the Input Data 103. The results of the action engine 140 are the output 150 of the content mining system 100.

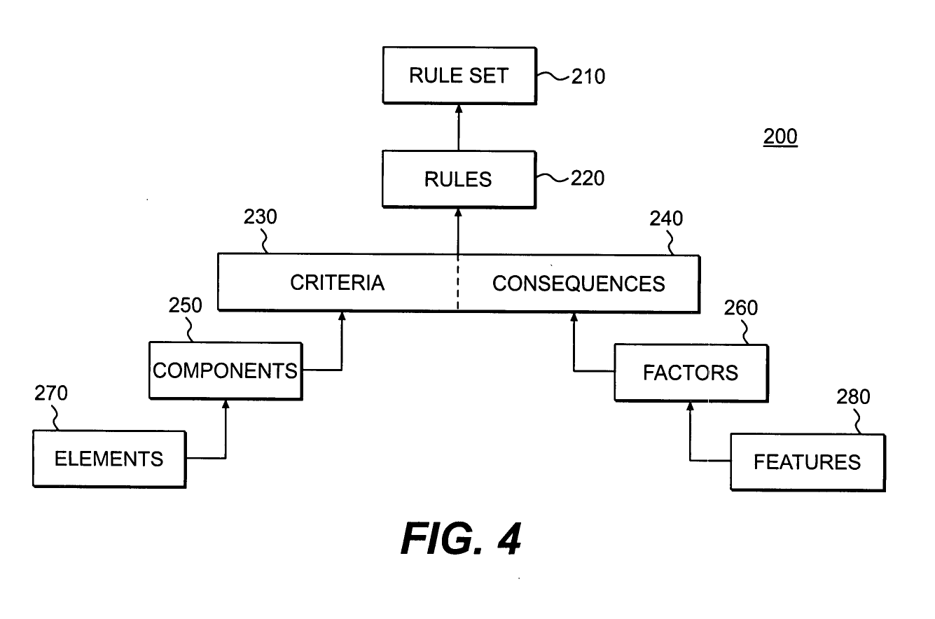

FIG. 4 shows an embodiment of a rules hierarchy 200 showing various items that comprise a rule set 210. The rule set 210 is made up of a collection of rules 220. The rules 220 are made up of a collection of criteria (e.g., patient diagnosis) 230. Each criteria 230 is made up of a collection of components (e.g., symptoms) 250. Each component 250 is made up of a collection of information elements or patterns of elements (e.g., heart rate, blood pressure, temperature, etc.) 270. The rules 220 further contain a consequence or series of consequences 240 that are acted upon or applied to the Input Data 103 (see FIG. 3) once given criteria(s) 230 or rule(s) 220 are met. Consequences 240 include any number of multiple factors 260, for example, but not limited to, “actions”, “labels” or “conditions,” which are applied to the Input Data 103. For example, an “action” of a series of symptoms could be to order a number of diagnostic tests for the patient. Each of the individual factors 260 may include multiple variables or features 280, such as an “action” of requesting diagnostic blood test for an ailment where the blood test will focus on certain blood gases, white blood cell count and so on.

The content mining system 100, and the rule set hierarchy 200, may be used by any group or organization that applies standards to the data the organization creates, processes, reviews or disseminates. Specific examples include, but not limited to, law enforcement agencies, such as police and the Federal Bureau of Investigation (FBI), the American Institute of Standards (AIS), national and international engineering associations, the accounting industry, the Centers for Disease Control and Prevention (CDC) and the health care industry.

More specifically, the FBI could use the present invention to assist in the analysis of criminal activity data and for the potential predictions of profiled criminal behavior. Criminologists would set the standards for profiling criminal activity and specify consequences for criteria met in the data analysis such as alerting other jurisdictions or public notifications or predicting where crimes may occur and therefore deploying manpower in given locations.

CPAs could use the present invention to assist in the analysis of financial records for various auditing circumstances. The standard practices for accounting could be established as a rule set and used to analyze financial data. Consequences could be the issuance of an audit or further examination of accounting practices by an auditing firm, Medical professional could use the present invention in the diagnoses of illnesses based on observed symptoms. Observed symptoms could be analyzed to either verify a diagnoses or help resolve a diagnoses based on medical standards.

Architects could use the present invention to determine if drawings meet industry standards.

Automated content mining using the content mining system 100 of FIG. 2 and FIG. 3 and the rules hierarchy 200 of FIG. 4 may also be used with the mandated classification management of U.S. government data, as well as management and control of private sector data. Classification management is the methodologies, processes and systems employed to manage and disseminate information based on specific guidance or rules governing how their content must be handled in terms of national security policies or private sector company/corporate level policies. By applying classification management to a collection of data, such as a document, the content of the data can be analyzed, categorized, manipulated, sorted, or otherwise handled. A three-tiered approach may be used to apply classification management to data:
1. A data/standards authority identifies rules governing the processing of data;
2. The data is searched and analyzed for any criteria specified in the rules; and
3. The data is processed or otherwise handled according to the rules.

U.S. government regulations mandate that documents are marked by portions, commonly referred to as “portion marking.” Portion marking is a specialized practice within classification management wherein a document and its component parts (paragraphs, sections, sub-sections, charts, tables, images, etc, collectively referred to as “portions”), are reviewed for information sensitivity or security classification, and are marked with the appropriate marking or combination of markings to reflect the classification of that particular portion of the document along with appropriate access and dissemination handling caveats of the data present in said portion under scrutiny.

Currently U.S. government document authors are required to read and review the content of a document, understand the significance of the content and their sensitivity, and finally appropriately mark each portion according to an established marking standard. This process is time consuming, prone to disparities due to the subjective nature of the reviewer, and plagued with errors, due to the large quantity of information that must be taken into account to complete the process successfully.

As used herein, a document portion includes the document's pages, sections, subsections, paragraphs, tables, figures or drawings, diagrams, images, and covers, a “word” includes an acronym, abbreviation, numerical value, icon, or other visual or text reference or expression, and a “phrase” includes more than one “word.” A marking consists of a symbol, icon, or text that unambiguously identifies the information sensitivity or classification of the marked portion. Additionally, as used herein, information sensitivity or classification includes data sensitivity such as privacy information and/or corporate proprietary information; also included is information relating to security classifications in terms of national security assets.

In its simplest form, portion marking is the process of determining whether given words and unique expressions that reflect sensitive or classified relationships exists in a document. Portion marking can be expressed in two basic formulas: (1) If sensitive or classified words or phrases exist in an of themselves in a document or portion of a document or (2) do given words or phrases (whether they are classified or unclassified combined together in context to yield a classified relationship. This situation is referred to as “aggregation.” For example, three separate words can combine together to create a classified relationship even though the words themselves are unclassified: a government agency, a project name, and a location, each of which is unclassified, when used together in a certain context, may create a classified fact or inference. Therefore, portion marking is simply the result of identifying words or phrases within a document to determine if their presence is of a sensitivity that warrants a certain type of mark or a classified relationship.

The markings that result form the portion marking process identify not only the sensitivity or classification level of the information, but also can typically include, but are not limited to, access control caveats and dissemination control caveats. For example, “COMPANY PRIVATE” or “CORPORATE PROPIETARY” as used in the private sector and “UNCLASSIFIED,” “CONFIDENTIAL,” “SECRET,” or “TOP SECRET” as used for information pertaining to national security represent sensitivity and classification levels respectively. For the purposes of discussions herein, even though portion marking can be used for both private sector sensitive information and national security classified information, the term classification level will refer to both usages. Typically, classification levels consist of a limited number of variables, which reflect hierarchy precedence, such as SECRET data considered of higher precedence than CONFIDENTIAL data and TOP-SECRET data being considered above secret data. Furthermore, only one classification level marking is typically applied to the data or information in question.

Access control caveats annotate who has the appropriate authorization to access the information in question; likewise, dissemination control handling caveats identify the expansion or limitation on the distribution of information. Typically, for access control and dissemination control caveats, there can be an unlimited number of these caveats with a much more complex ordering of precedence relationships. For instance, only certain access and dissemination control caveats correlate to a given classification level and may not be used with other classification levels. Also, unlike the classification levels that only utilize one level for the data or information in question, there can be any number of access and/or dissemination control caveats that can apply to the same data or information. Therefore, the complexity of portion marking is quite daunting considering that there are multiple variables with multiple ways the variables may interact with one or more of the other variables. All of these interactions are typically identified to some degree by a standards authority that is responsible to assure proper data/information classification, access control and dissemination control are carried out correctly.

To execute portion marking in prior art systems, a human operator (reviewer), carrying out the approach outlined above, reviews a document looking for specific words or phrases, or numerical values, for example, that reveal sensitive or classified information. When these words, phrases and numeric values appear in the document, the operator manually “marks” the appropriate document portion(s) with the required marking(s).

To properly perform the portion marking function, the reviewer must have an in-depth working knowledge of the sensitive/classified information contained in the document being reviewed, as well as the appropriate sensitivity/classification marking guidance from the appropriate data/standards authority for the document. The reviewer then reviews/analyzes the document on a portion-by-portion basis, followed by a comprehensive document review/analysis wherein the markings for the document as a whole are considered. The review is not only time-consuming, but the results can be very subjective, leading to inconsistencies and errors in the implementation of portion marks from one portion to another and/or one document to another of similar content and subject matter. This is due to the possible complexity and volume of the content within a given document or series of documents.

As mentioned above, in order to apply classification management and the portion marking process to a document, the rules governing that document must be known. A rule set encapsulates all rules and other supporting data that are required to process a given document. Each individual rule consists of criteria that are used to determine if the rule applies to the given content and consequence(s) that is applied to the given content if the rule is determined to apply. A criteria, in its simplest state, consists of one component or element, i.e., data (textual or otherwise) that is required to be found within the given content in order to satisfy some condition. This data may be fixed or it may be a known signature, such as a Social Security Number. A more complex criteria may consist of one or more components and/or elements or patterns of components and/or elements that are logically evaluated as a condition. That is, each criteria pattern within a rule must be acted upon by a logical (Boolean) operator to determine if the condition has been met. For example, criteria A might be created that consists of components B and C and a pattern of elements D that are logically related with the “and” operator. Further, the pattern of elements D consists of criteria E and F that are logically related with the “or” operator. Criteria A can be expressed B and C and (E or F). Therefore, criteria A would be satisfied only if both criteria B and C and either criteria E or F or both were found in the given content. In this way, complex criteria can be created to logically express a desired condition. If the condition is met, the specified consequence applies to the given content.

To further complicate the process of matching criteria for a given pattern, the data may be arranged in any unspecified order. For example, if three criteria A, B and C are specified, these criteria can be arranged in six unique ways; shown thusly: ABC, ACB, BAC, BCA, CAB and CBA. The total number of permeations of unique arrangements can be shown mathematically: 3×2×1=6 or by the factorial method: 3!=3×2×1=6. The number of unique arrangement permeations grows exponentially as the number of criteria to be searched for and matched increases. For instance: 4!=24; 5!=120; 6!=720 . . . 13!=6,227,020,800; 14!=87,178,291,200 and so on. This is referred to herein as the factorial issue.

To automate the portion marking and verification processes, an embodiment of the data mining system 100, referred to hereafter as a portion marking verification tool (PMVT), may be used. The PMVT works in conjunction with other computer-based programs, such as a word processor. More specifically, the PMVT may use document formatting and construction rules specified by the word processor to identify a document's various division features, including pages, sections, subsections, paragraphs, tables, figures or drawings, diagrams, images, and covers. Using these word processor-defined rules, the PMVT can search each distinct document feature according to a set of criteria patterns to identify classified words and phrases, and relationships between words and phrases.

The PMVT operates in several phases, including tool loading, document scanning, and user verification with automated portion marking. The tool loading phase includes initial load of a rule set or sets to be used for documents review, scanning, and verification with portion marking. The rule set may be contained in an electronic version of a standards authority's classification guide, and may be loaded into a pattern/rule set database that is a part of the PMVT. The rule set database may contain any number of guides and sets of marking rules. For example, the pattern/rule set database may include classification guides for defense department organizations and for civilian intelligence agencies. The pattern/rule set database is likely to contain sensitive information itself, and access to the database would, accordingly, be restricted by various combinations of user names, passwords, encryption, and other security measures. Alternatively, access to one or more of the individual classification rule set in the rule set database may be controlled by security measures for the individual rule sets.

A second phase of PMVT operation is an automated scanning phase. The document is screened for instances of words, phrases, numbers, acronyms, etc., and relationships between said items that are of interest according to the selected rule set. A document to be screened can be thought of as akin to a tree structure in a database. The overall document is the root of the tree structure. The tree structure uses many hierarchical levels, or branches, to describe the tree. Thus, the document may be broken down into regular features such as chapters, sections, pages, paragraphs, sentences, and words, with each of these regular features corresponding to a specific hierarchical level (branch) of the tree. The document may also contain special features such as titles, headers and footers, footnotes, embedded objects, and other features. Some or all of these regular and special features may describe a document portion. As each portion of the document is reviewed by the PMVT, that portion is flagged for marking with the appropriate classification level, access control, and dissemination control caveats. The scanning phase continues until the entire document is scanned and flagged for marking. This phase of the PMVT operation may proceed automatically and without any human reviewer oversight or direct involvement.

Following the scanning phase, or incrementally through out the scanning phase, the PMVT operation moves to a verification phase. During the verification phase, a reviewer/operator reviews the portion markings suggested by PMVT, and the reviewer/operator either accepts or changes the portion markings that PMVT suggests. The reviewer/operator may modify any aspect of the suggested markings that it sees fit. To perform the verification phase, PMVT outputs the tentatively portion-marked document onto a user interface that includes tools to allow the operator/reviewer to accept the marking set that the tool recommends or modify the marking set as necessary. The tool advances in a portion-by-portion mode as the reviewer/operator reviews the overall marking of each portion through out the document. The user interface also includes other tools that allow the reviewer/operator to track progress of the verification phase.

When multiple occurrences otherwise known as “hits” within a portion of the document take place, then that portion is marked according to the highest classification level for any of the individual hits. Thus, for example, if a portion contains three hits with three successively higher classification levels, the portion containing the three hits would be marked at least with the classification level of the highest-classified paragraph, if that is what the aggregation rules dictated.

Additionally the PMVT is capable of using complex interaction between markings that include but are not limited to classification levels, access control caveats and dissemination control caveats obtained from the pattern set to determined what the final outcome of multiple hits aught to be.

The PMVT can be implemented in a variety of scenarios. In an embodiment, the PMVT is provided on a computer readable medium, and can be loaded onto a suitable computer or processor to complete the three phases of PMVT operation. In this embodiment, the computer or processor would be connected to the required peripheral devices, such as a visual display, to enable use of the user interface for the reviewer/operator verification phase.

In another embodiment, the PMVT resides at a central location and documents are either brought, from a remote location, to the central location in a fixed media such as an optical disk, for example, or are transmitted electronically to the central location. Once the documents are at the central location, the PMVT operation is completed, and a properly portion-marked document is returned to the remote location.

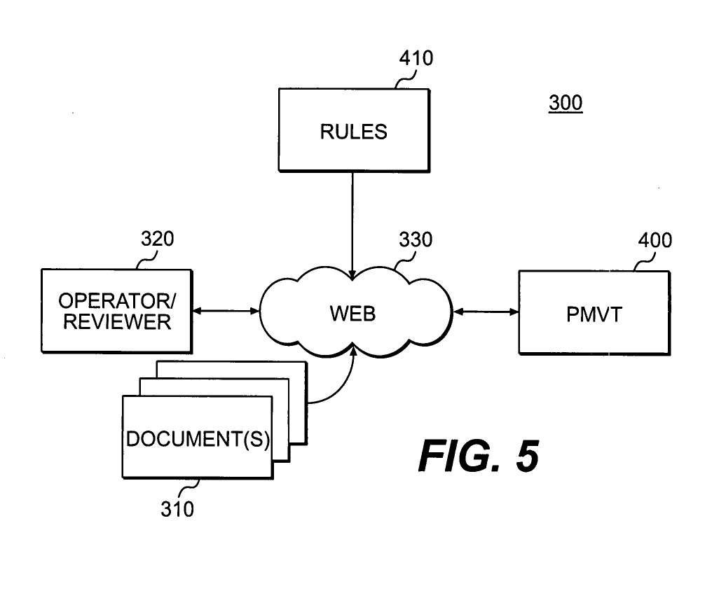

FIG. 5 illustrates the embodiment of a network 300 in which the automated portion marking verification tool (PMVT) 400 is used for classification management of documents; wherein documents 310 are sent from a remote location to a central location for processing. In FIG. 5, an operator/reviewer 320 at a remote location has one or more documents that require portion marking according to specific classification guides. The PMVT 400 operates at a central location, and is capable of automatically portion-marking the documents. The remote location and the central location are coupled by, for example the Internet/Web 330. Alternatively, the remote and central locations could be coupled as part of a local area network (LAN). The central and remote locations may be coupled by wireless means or by wired means.

The PMVT 400 has access to analysis rules, in an analysis rules database 410. The analysis rules may include classification criteria, access criteria, dissemination criteria, for example. The analysis rules are in accordance with classification guides, and may be provided by the operator/reviewer 320 when documents are submitted to the central location, or may be installed at the central location on a more permanent basis. The operator/reviewer 320 transmits the desired document(s) 310 to the PMVT 400 at the central location over the Internet 330. Alternatively, the documents 310 can be transmitted on a physical medium such as an optical disk, for example. After the PMVT 400 process is completed, the portion marked document is returned to the operator/reviewer 320.

In addition to the rule set(s) installed at the central location on a more permanent basis, the PMVT 400 may access analysis rules contained in analysis rules database 410. The PMVT 400 accesses the database 410 using a Web portal and the Internet 330. The database 410 may reside at a Web site of the government agency or other entity.

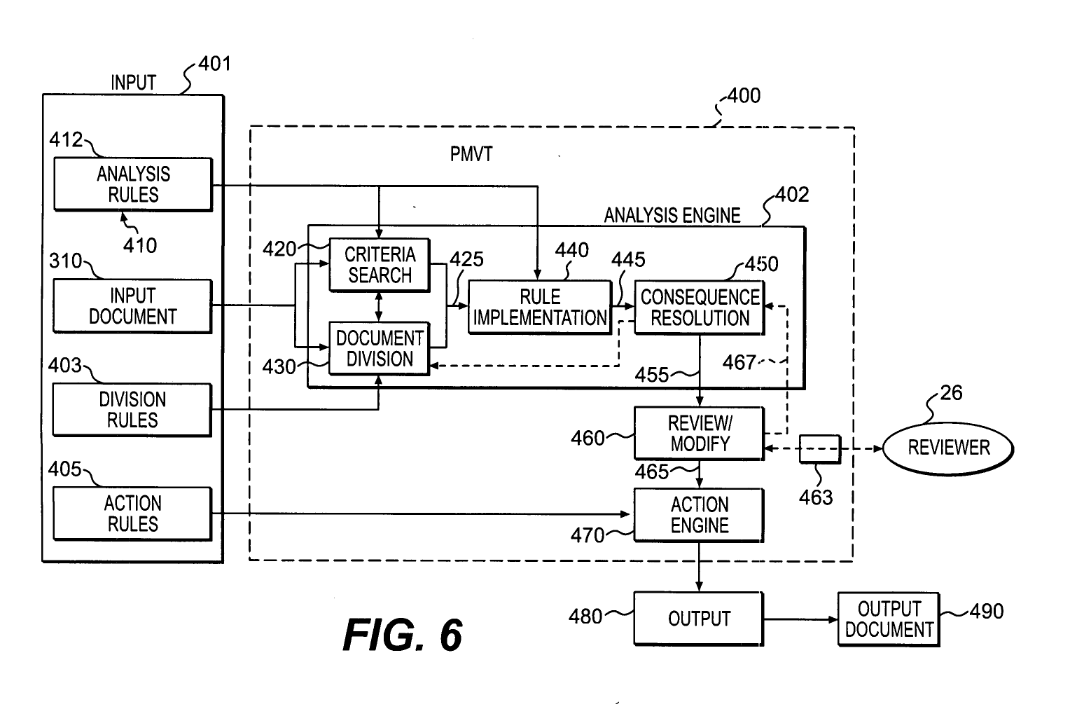

FIG. 6 is a block diagram of an embodiment of the PMVT 400 of FIG. 5. In FIG. 6, the PMVT 400 is shown receiving input 401 and producing an output document 490. The PMVT 400 includes analysis engine 402. The analysis engine 402 includes a criteria search module 420 and a document division module 430, both of which, as shown, receive an electronic version of the input document 310. Other inputs to the criteria search module 420 include analysis rules 412 from the analysis rules database 410 and document division information from the document division module 430. Other inputs to the document division module 430 include document division rules 403 and search results from the criteria search module 420.

Also included in the PMVT 400 is rule implementation module 440, which receives a combined output 425 of the criteria search module 420 and the document division module 430. The rule implementation module 440 also receives analysis rules 412 from the analysis rules database 410. Each Rule in the analysis rules 412 specifies Criteria that must be satisfied to render the Rule applicable. The Rule's Criteria comprises a set of Components that must exist or not exist within a given document portion to satisfy the Criteria. The conditions governing the existence of Components within a portion are specified in the Criteria and are expressed as Boolean operators, e.g., AND, OR, NOT, XOR. These guidelines are used in conjunction with the outputs of the criteria search module 420 and the document division module 430 in order to determine the applicability of a Rule to a given portion. The output of the criteria search module 420 is a mapping of Elements of Components to their location (if any) in a given portion or set of portions. The output of the data division module 430 is a portion or set of portions that are logical sections of the input document 310. An output 445 of the rule implementation module 440 is a set of portions associated with any applicable Rules.

In an embodiment, the criteria search module 420 and the data division module 430 act in serial, in parallel, or in an alternating fashion until all of the input document 310 has been processed. The intersections of the outputs of the criteria search module 420 and the data division module 430 define the Components in each portion that will be considered by the rule implementation module 440.

In an embodiment, the data division module 430 may direct its output to the criteria search module 430 after each portion is defined. In such an embodiment, the output of the criteria search module 420 will then direct its output to the rule implementation module 440, which will return control to the data division module 430 in order to process the next portion of the document 310, if any. In this embodiment, each portion is determined and its applicable analysis rules 412 are applied (if any) in turn.

In an embodiment of the PMVT 400 for Microsoft Word®, the criteria search module 420 determines the location of each Element that composes each Component that is referenced by any Rule in the supplied analysis rule set 412. The input document 310 is then divided into portions by the data division module 430 as governed by the data division rules 403. These rules 403 are designed to divide a Microsoft Word® document into portions, as defined by the Intelligence Community Classification and Control Markings Manual also known as the CAPCO Guide. For example, in general, each text paragraph is treated as a portion. However, if a group of paragraphs is identified as a table, then that set of paragraphs is treated as a single portion. Other Microsoft Word® constructs may be handled similarly, such as Tables of Contents, lists, or embedded objects (e.g., images, etc.). Each portion is a Context that is defined by a particular range in the document. Any location of any Element that falls within the range of a particular portion indicated that the associated Component exists within the portion. The analysis rules 412 that apply to each portion may then be determined. Certain portions that are not well suited for analysis, such as embedded images, may be handled by a customized process.

The rule implementation module 440 provides the output 445 to consequence resolution module 450. The consequence resolution module 450 resolves any conflicts among or between consequences of the analysis rules. Conflicts may include, but are not limited to, precedence issues and mutual exclusivity. The consequence resolution module 450 provides output 455 to review/modify module 460. The output 455 is a set of portions and their associated consequences.

In an embodiment, the consequence resolution module 450 acts upon a document portion that has been processed by the rule implementation module 440. In such an embodiment, the full set of document portions will be processed by the consequence resolution module 450 before control is passed to the review/modify module 460.

In another embodiment, the consequence resolution module 450 acts upon one document portion at a time. In such an embodiment, control will be returned to the data division module 430 so that the next document portion, if any, may be processed. Once all document portions have been processed, control is passed to the review/modify module 470.

In yet another embodiment, the consequence resolution module 450 may take input 467 from the review/modify module 460. In such an embodiment, the set of applicable analysis rules may be changed by the Reviewer 26. These changes may necessitate further consequence resolution.

In an embodiment of PMVT 400 using Microsoft Word®, the set of processed marked document portions is processed by the consequence resolution module 450. This set is then passed to the review/modify module 460, where the applicable classification (portion marking) of each portion may be modified. The modification of any applicable portion marking may necessitate that the document portion be reprocessed by the consequence resolution module 450.

The review/modify module 460 receives the output 455, and also interfaces with Reviewer 26 through interface 463. An output 465 of the review/modify module 460 is provided to action engine 470, which also receives an input from action rules 405. The action engine 470 is coupled to output module 480, which produces a final, portion-marked version of a document.

The action engine 470 takes two inputs: the set of portions and associated consequences from the review/modify module 460 and a set of action rules 405. The action Rules 405 contain directions as to what action or actions, if any, are warranted by a given set of consequences. These actions are preformed for the set of consequences associated with each document portion. These actions may include, but are not limited to, the modification of the input document 310, the creation of reports based upon the analysis of the input document 310, or the routing of the input document 310. The output of the action engine 470 is the final output of the PMVT 400.

In the embodiment of PMVT for Microsoft Word®, the action engine 470 marks the input document according to the consequences applied to each portion and to the document as a whole. For each portion, a marking representing the set of associated consequences is inserted at the beginning of the range. Then, the document as a whole (an implied portion) is similarly marked.

The output module 480 is used to produce a final version of the portion marked document, in either electronic or hard copy format, or both.

The analysis rules database 410 includes one or more sets of analysis rules (rule sets) that are used for portion marking of documents. The rule sets may be generated by the agency or entity requesting the portion marking and verification service, and access to the rule sets may be restricted when the rule sets themselves contain confidential or otherwise restricted information. The rule sets may be adapted from a formal classification guide. For example, a classification guide may normally be provided in hard-copy format, and that format would then be adapted to allow use by the PMVT 400.

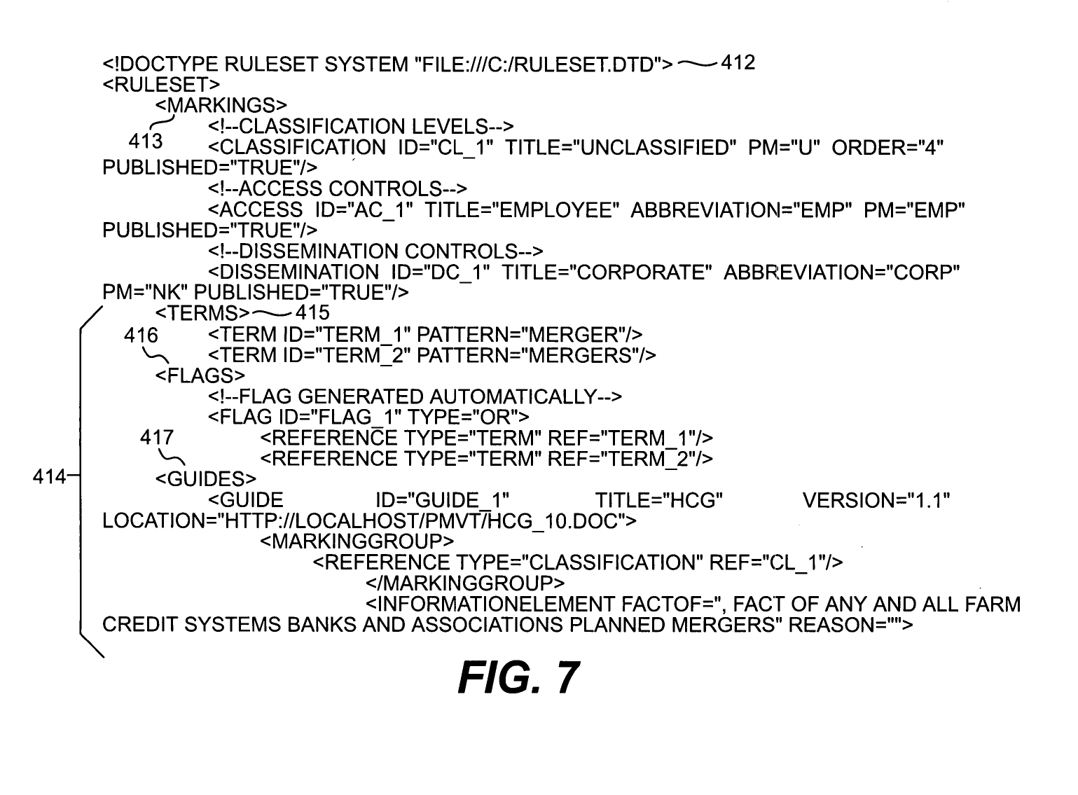

FIG. 7 illustrates a fragment of an exemplary analysis rule set 412. The rule set 412 contains one or more sections, including header sections 413 and content sections 414. The header sections 413 include classification levels, access controls, dissemination controls, and declassification date, which are consequences. The content sections 414 include a term section 415 that list terms as individual words, with each term having an associated identification (id). A flag section 416 includes one or more flags that comprise terms built with either a Boolean “or” or a Boolean “and.” These Boolean expressions are used in the normal Boolean context to determine if any one of the terms is present, or if all of the terms are present. Finally, a rule section 417 contains individual rules. The rule section 417 is further divided into four subsections: subsection 1 provides a marking of the rule itself; subsection 2 provides an information element, with the classification of the element; subsection 3 provides the rule itself, and the flag to point to; and subsection 4 provides any further subsections that may exist.

As noted above, the rule set may be provided by a government agency or entity requesting the portion marking and verification service. The rule set may be provided at the time the service is requested, and may be stored in the analysis rules database 410 on a temporary basis. Alternatively, the rule set may be stored on a long-term basis, and would be used whenever the government agency or entity request that a document be processed. When the rule set is provided in Web-accessed database 410, the government agency or other entity can control access to the rule set.

Returning to FIG. 6, the analysis rules are loaded from the databases 410 or 411 into the criteria search module 420 at the time that the portion marking and verification is to be completed. Loading of the appropriate rule set may be automatic, manual, or semi-automatic. For an automatic load of a rule set, the document to be portion marked may contain a key or password that would call up the appropriate rule set. If the mode is semi-automatic, the called rule set would be verified by the human reviewer before the portion marking begins. In a manual mode, the human reviewer selects the appropriate rule set from the analysis rules databases 410 or 411.

The rules implementation module 440 interfaces with the criteria search module 420 to apply the analysis rules to the document 310 to be processed. That is, the criteria search module 420 will search the document 310 using the words and phrases, and their express relationships, that the selected analysis rule set provides.

The criteria search module 420 may use any number of search algorithms to search for the words, phrases, and relationships provided in the selected analysis rule set. One such algorithm is a tree search algorithm. Tree search algorithms are, in general, well known in the art. Using the tree search algorithm, the criteria search module 420 first completes a search of the document for any instances of restricted words, phrases, or relationship. When one of these restricted words or phrases are located by the criteria search module 420 within a document portion, that portion is temporarily marked with the appropriate classification level. However, since words and phrases can combine to provide a classified conjunction, the tree search algorithm also searches for these restricted conjunctions or relationships. For example, the association of a project name with a specific government agency may be restricted whereas the project name and the identity of the government agency, standing alone are not restricted. The search algorithm determines if two or more words or phrases show an association that is restricted. For example, if the project name and the government agency name appear in the same document paragraph, or within a predetermined number of words of each other, or in the same sentence, then the associated document section is classified according to the restricted relationship stated in the analysis rules.

To execute the consequence phase of the search, the criteria search module 420 is provided with specific document information (document rules) related to formatting and structure of the document 310. For example, a document formatted according to a standard word processor program may insert into the electronic version of the document, code related to section breaks and page breaks, paragraph breaks (e.g., a hard return key stroke), headers and footers, footnotes, embedded objects, titles, and other word processing features. These document rules are provided to the criteria search module 420 through the document division module 430, or may be provided directly to the criteria search module 420.

In an embodiment, the results of the search for restricted words and phrases and the conjunction of these restricted words and phrases is provided to the rule implementation module 440 as each document portion is searched. Thus, once a paragraph is searched, the search results for that paragraph are provided to the rule implementation module 440, which then marks the paragraph with the appropriate annotation. This procedure continues throughout the document. However, as individual document portions are searched and marked, the attendant classifications levels are “rolled-up” such that the next higher document portion is marked according to the markings of lower level document portions. Thus, the document is marked to at least the highest level of any paragraph, header/footer, or footnote of the document. A section or chapter is marked according to the highest classification level of any page in the section of chapter. Furthermore, a conjunction of unrestricted and/or restricted words and phrases in lower level document portions may result in a higher classification level for the next higher document portion. Thus, for example, a chapter may be marked with a higher classification level than any one page in the chapter.

The criteria search module 420 and the rules implementation module 440 combine to execute an automated process to search and mark all the document portions that match the criteria from the analysis rules database 410. The rules implementation module 440 places appropriate annotations into a securely copied version of the original document so that the original document is left intact.

The consequence resolution module 450 provides the document to the review/modify module 460 for display and verification of the markings. Using the review/modify module 460, the Reviewer 26 can verify that each document portion marking decision is correct. The Reviewer 26 can verify or accept the portion marking decision, raise the classification level, or lower the classification level. If the reviewer 26 raises or lowers the classification level, the document portion is remarked by the consequence resolution module 450 with the appropriate annotation. Any raising or lowering of the classification level for a specific document portion will then be “rolled up” with the next hierarchical level of the document. Thus, if the Reviewer 26 increases the classification level of a paragraph, then the consequence resolution module 450 will raise the classification level of the associated page or section, as appropriate. Alternatively, the consequence resolution module 450 may provide a warning that the associated page's classification level should be changed. The consequence resolution module 450 may provide the warning by way of a pop-up window. The consequence resolution module 450 may also prevent further portion marking verification until the reviewer has “cleared” the warning by taking action to increase the classification.

Once the Reviewer 26 has completed the verification phase, an output, such as the document 490 with all its annotations entered, is provided to the output module 480. The output document 490 may be in electronic format according to the format of the original document. Alternatively, or in addition, the document may be printed. Finally, the output document 490 may be a file containing code designating the annotations for each document portion. For example, the output file may be saved in an .XML format. The output is then provided to the operator/reviewer 320 (see FIG. 5).

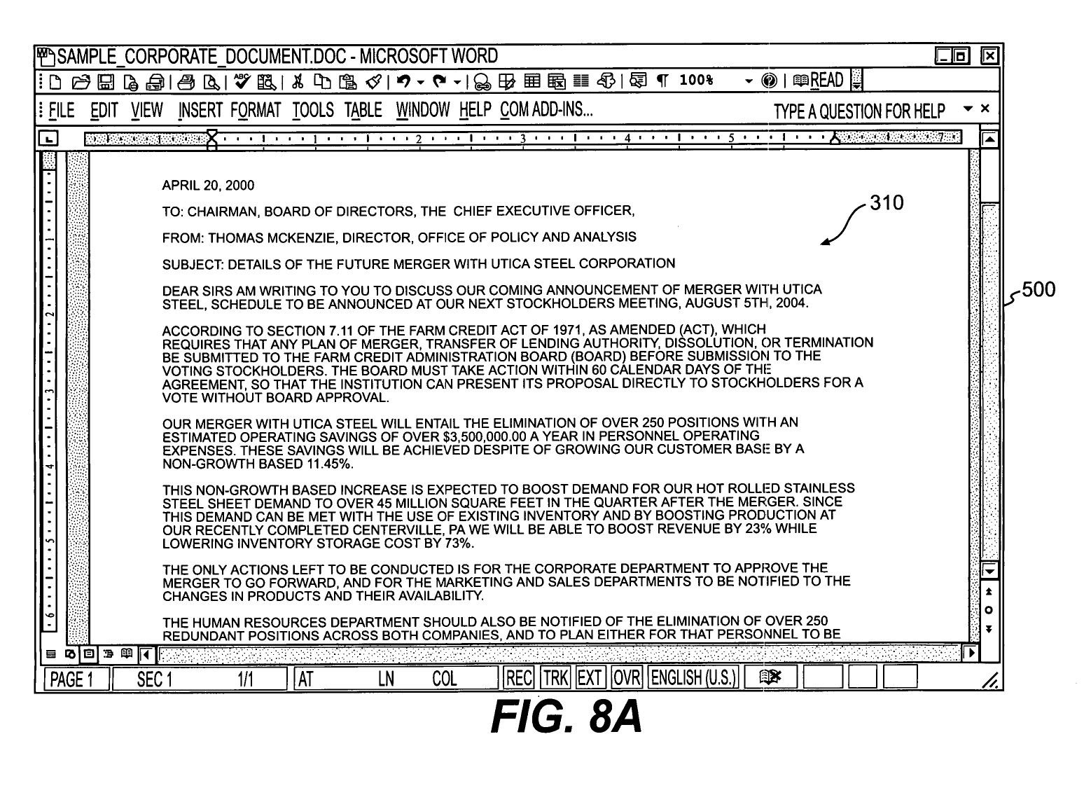

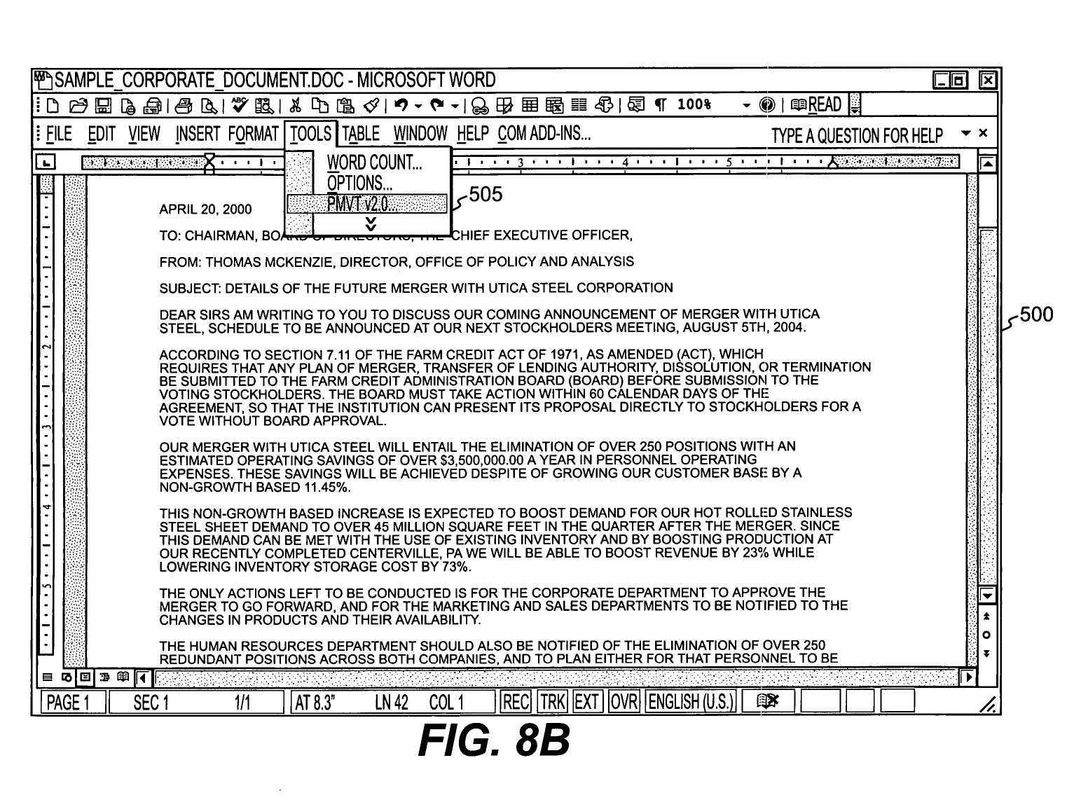

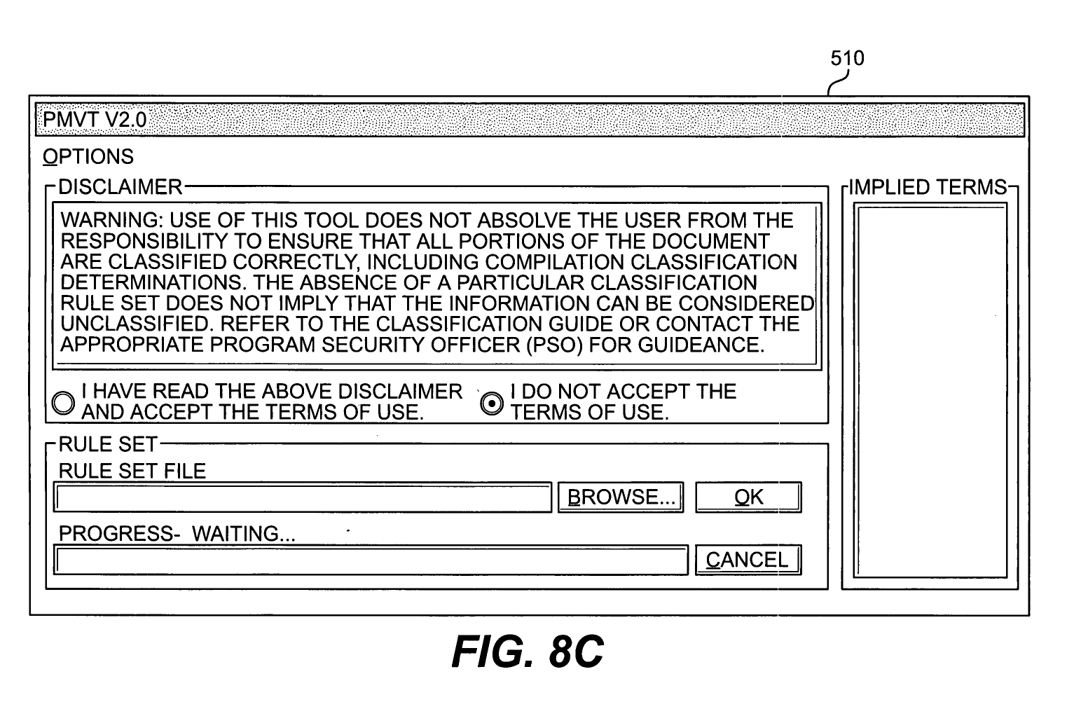

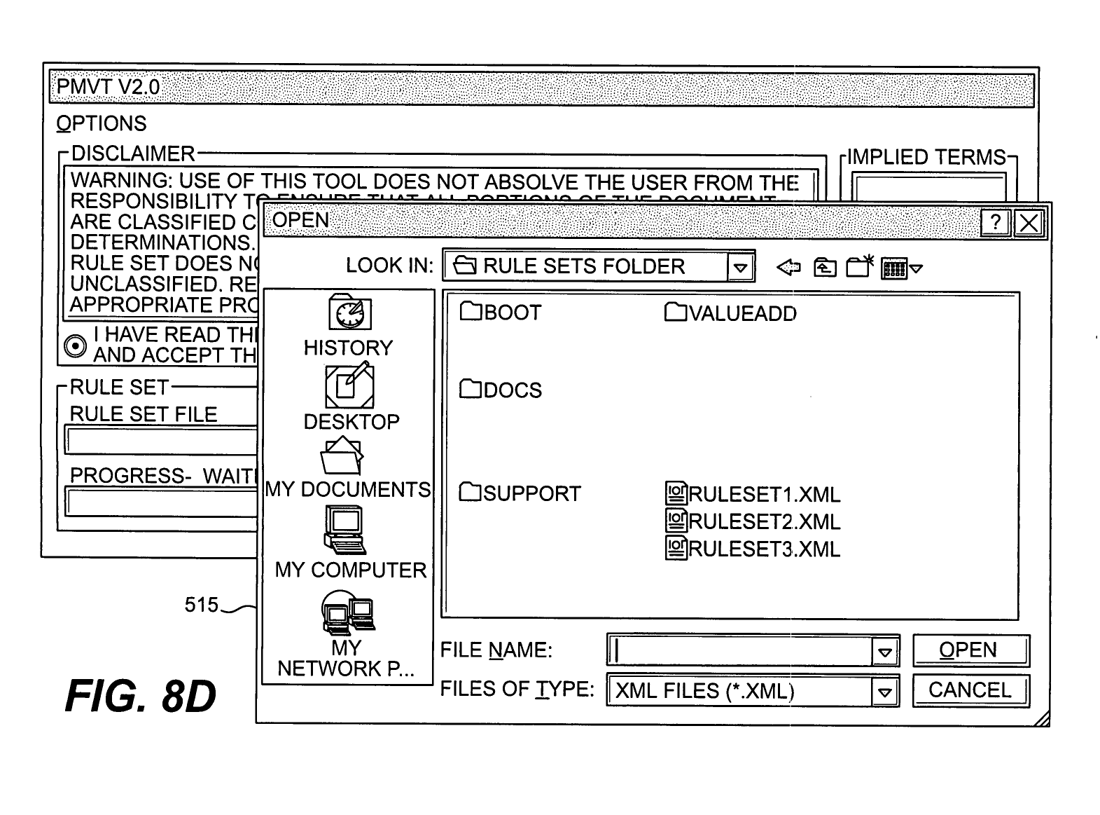

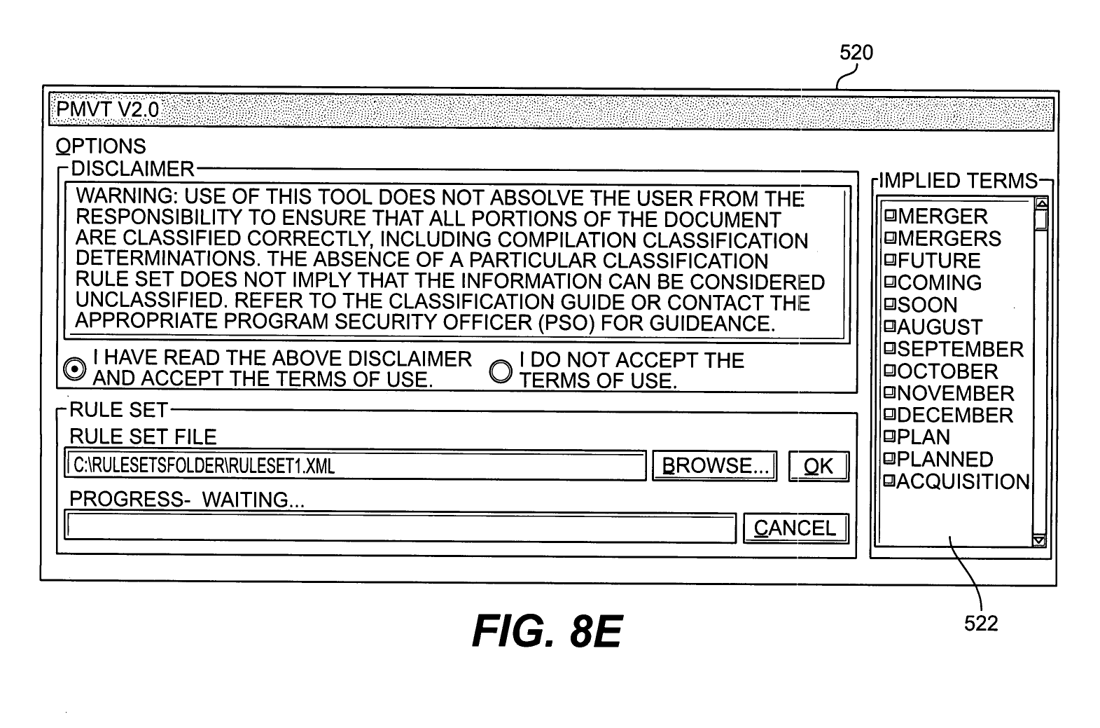

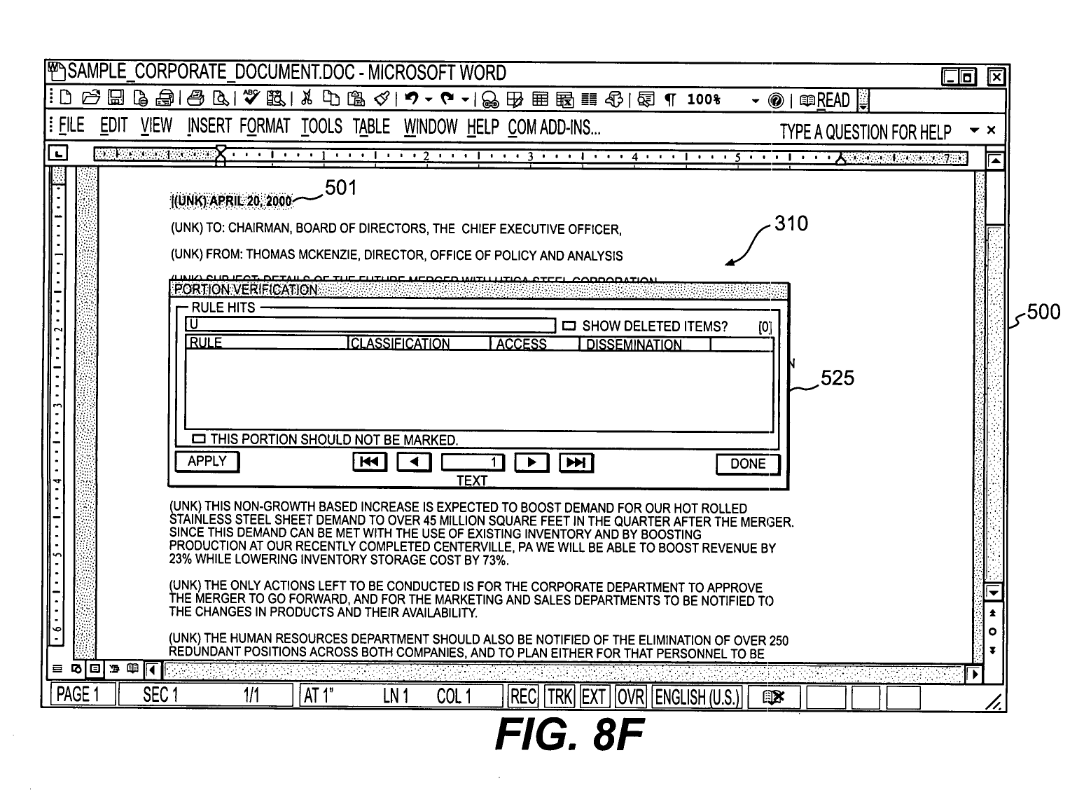

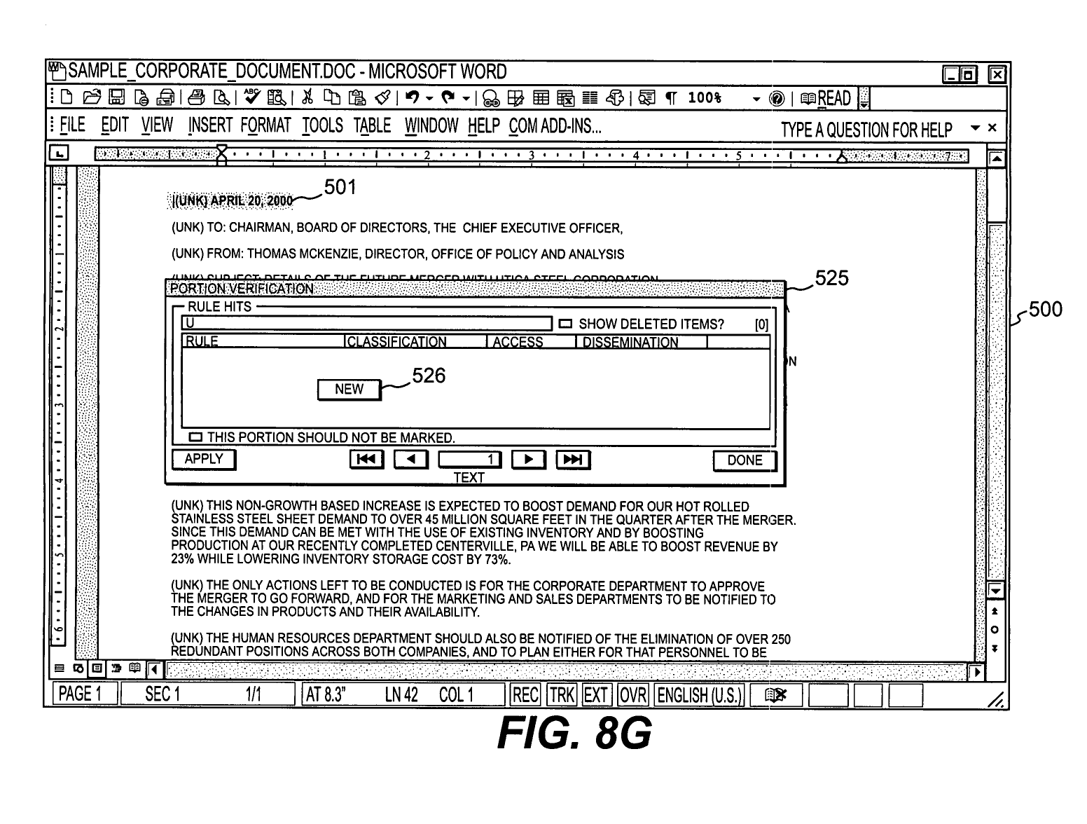

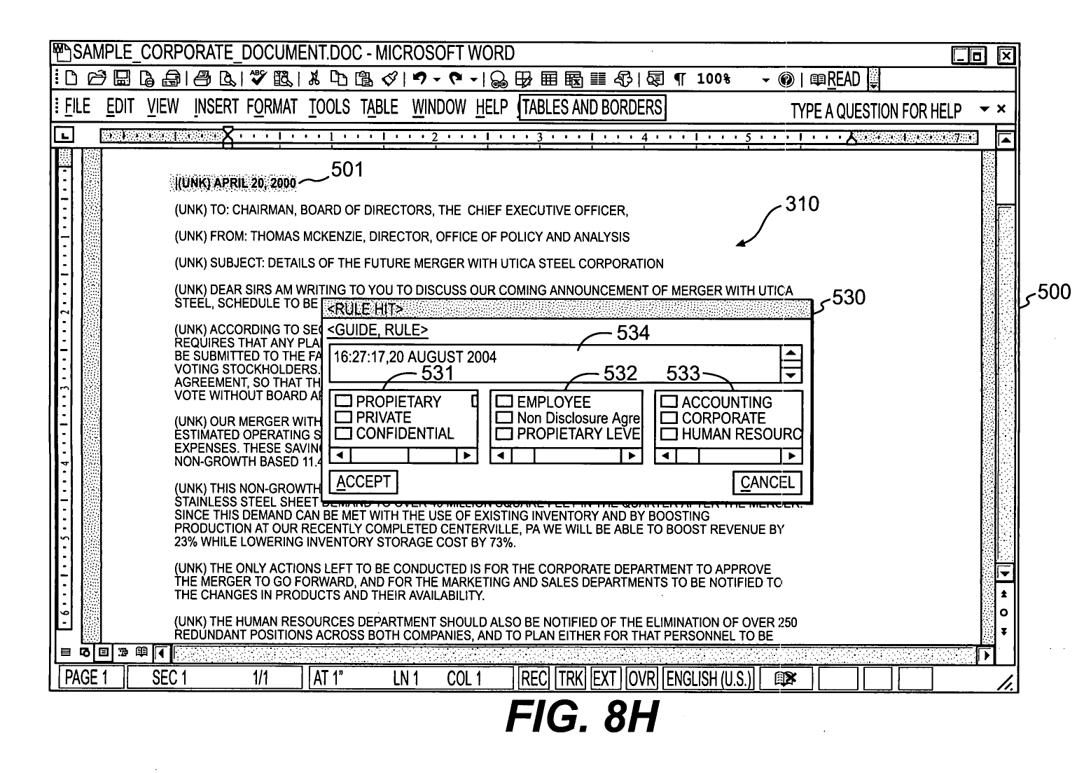

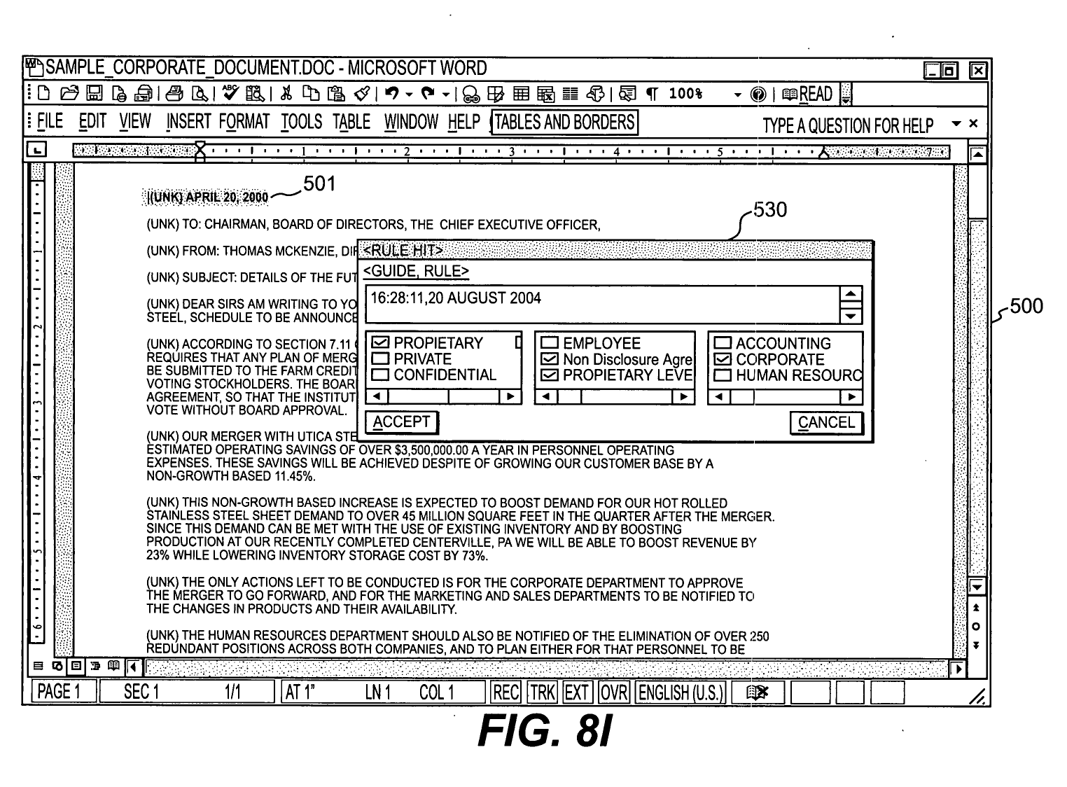

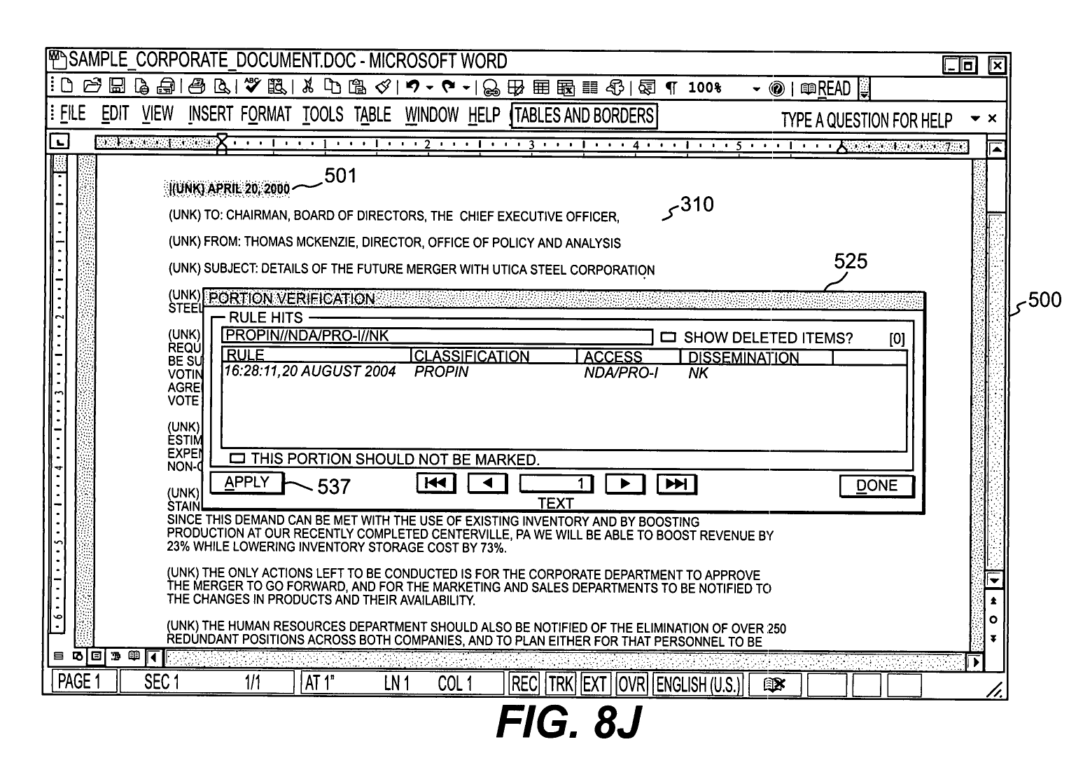

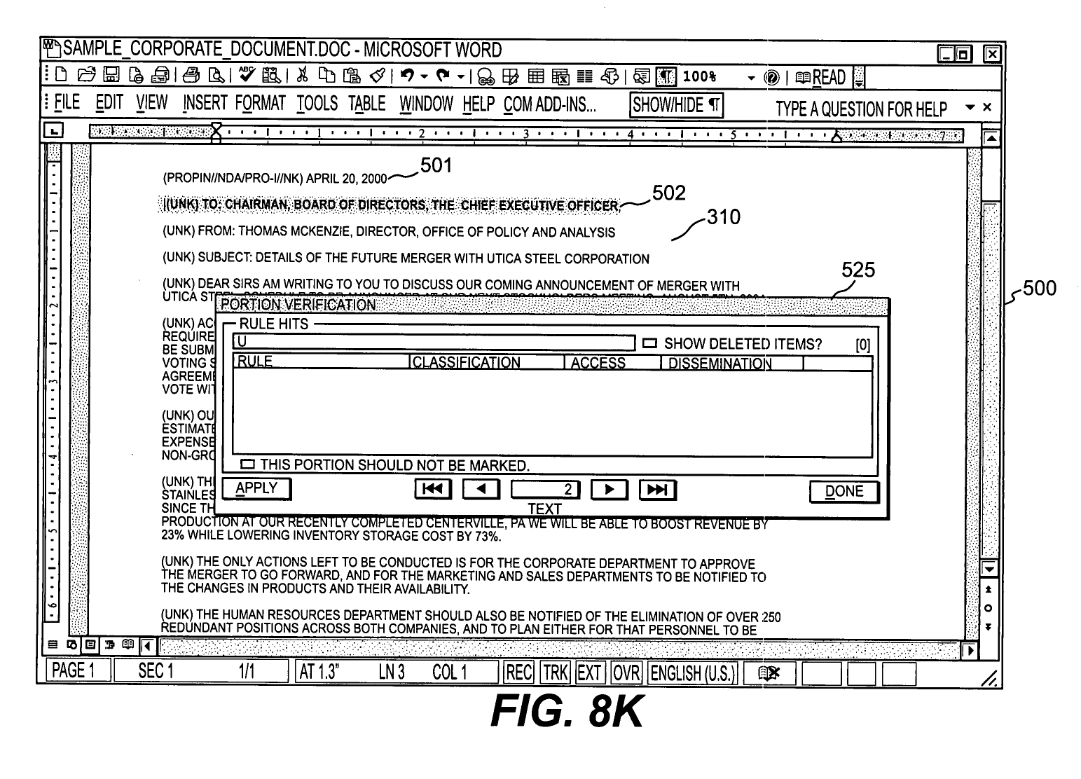

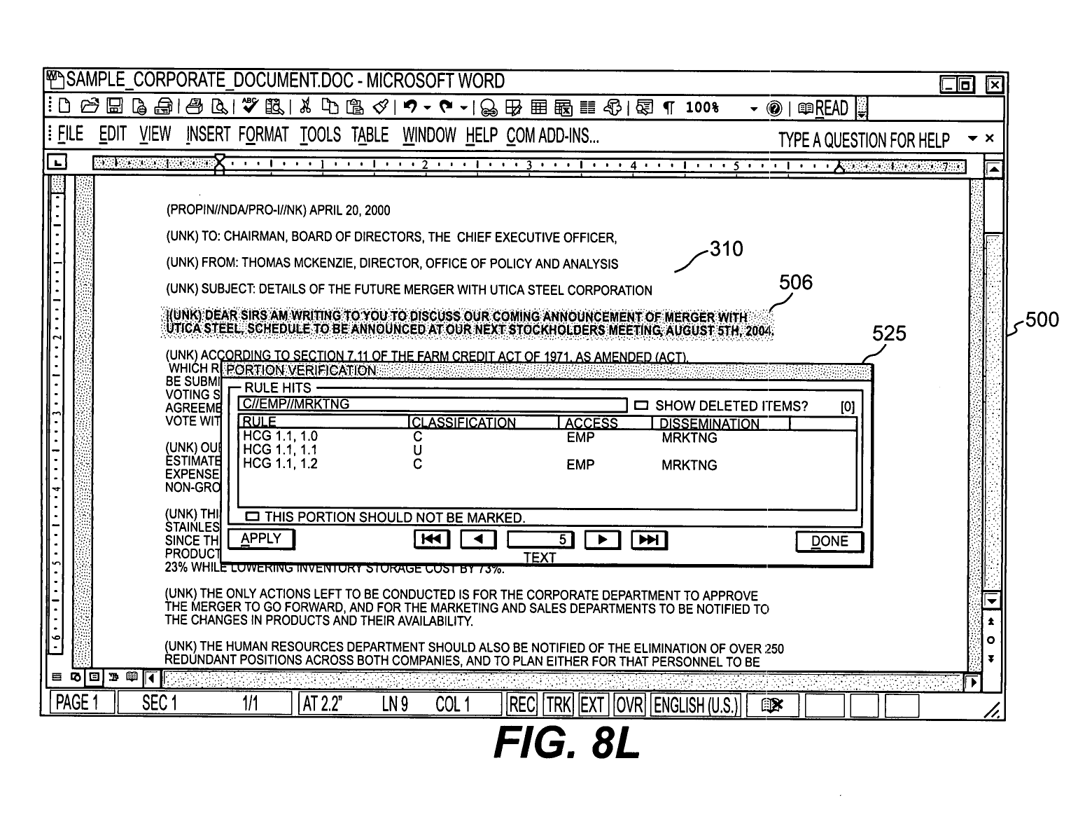

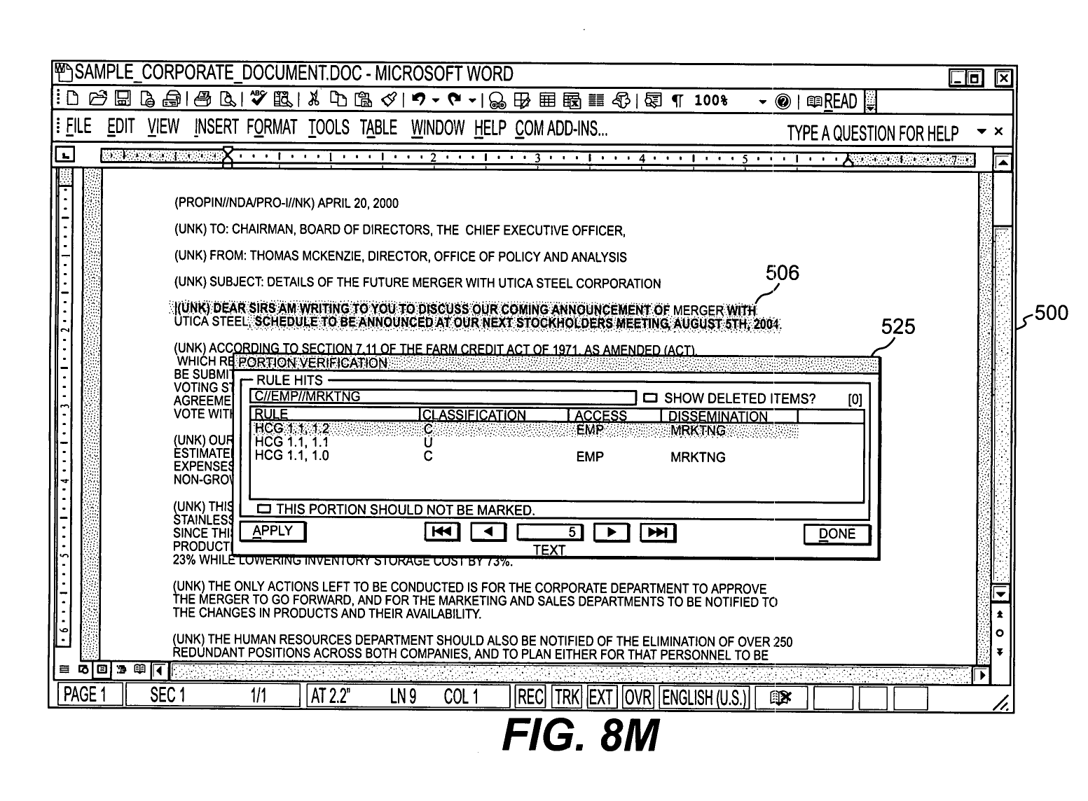

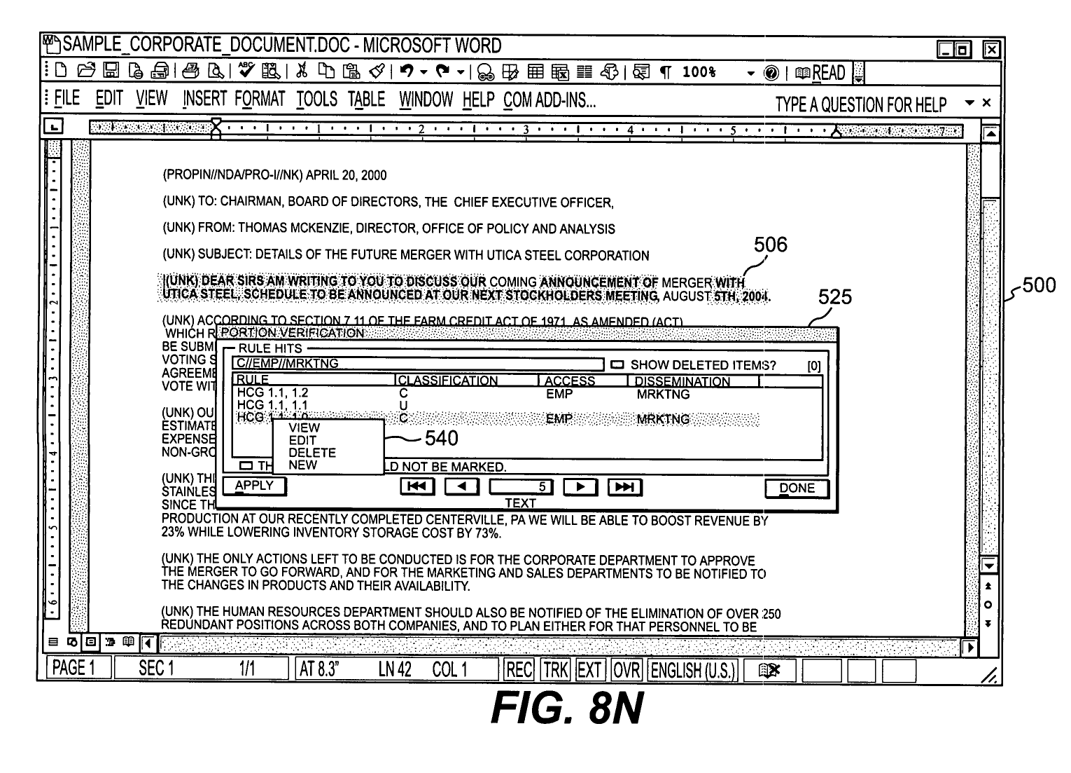

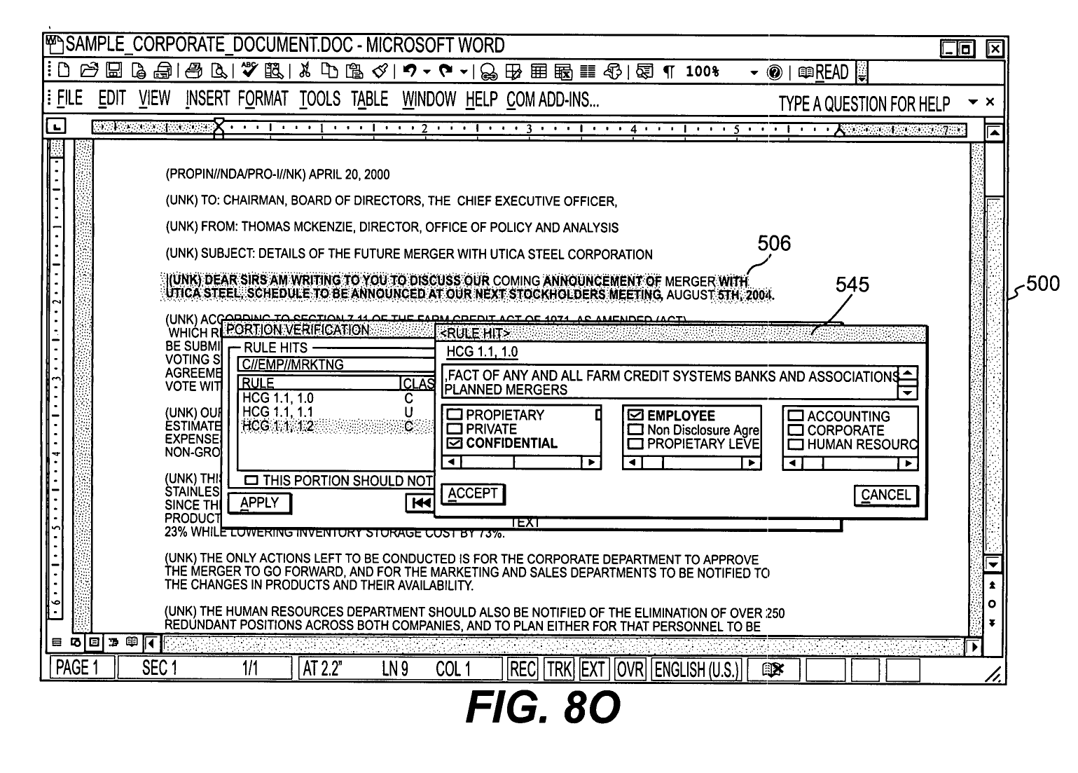

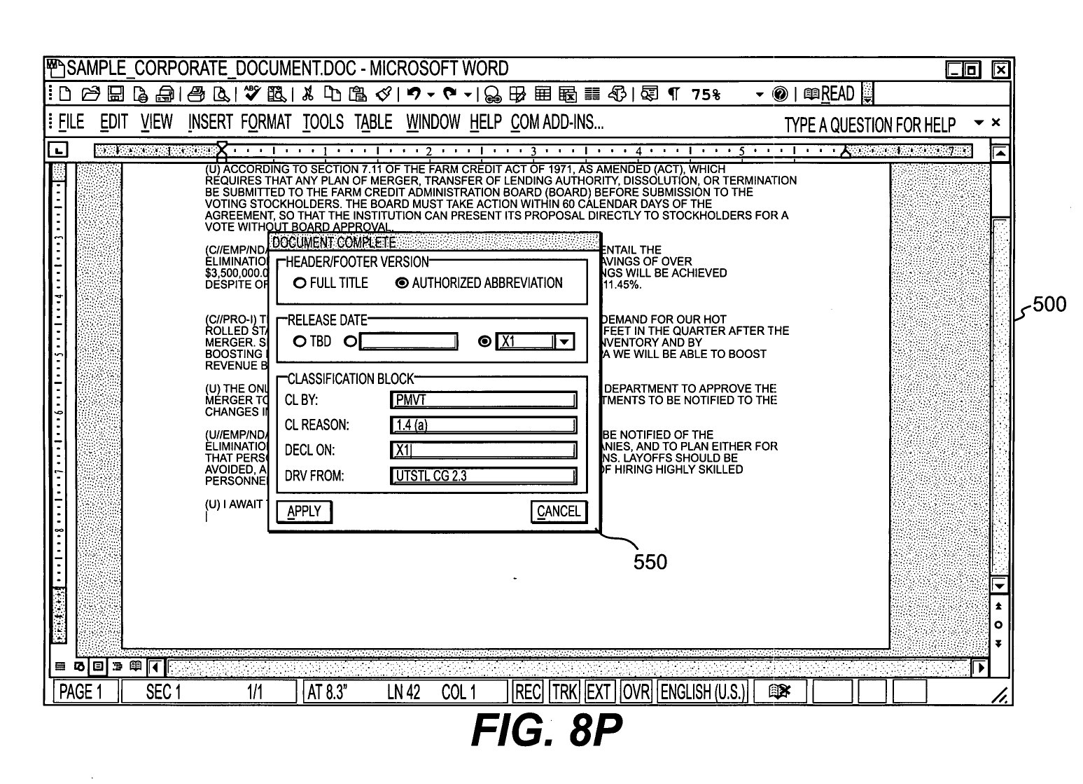

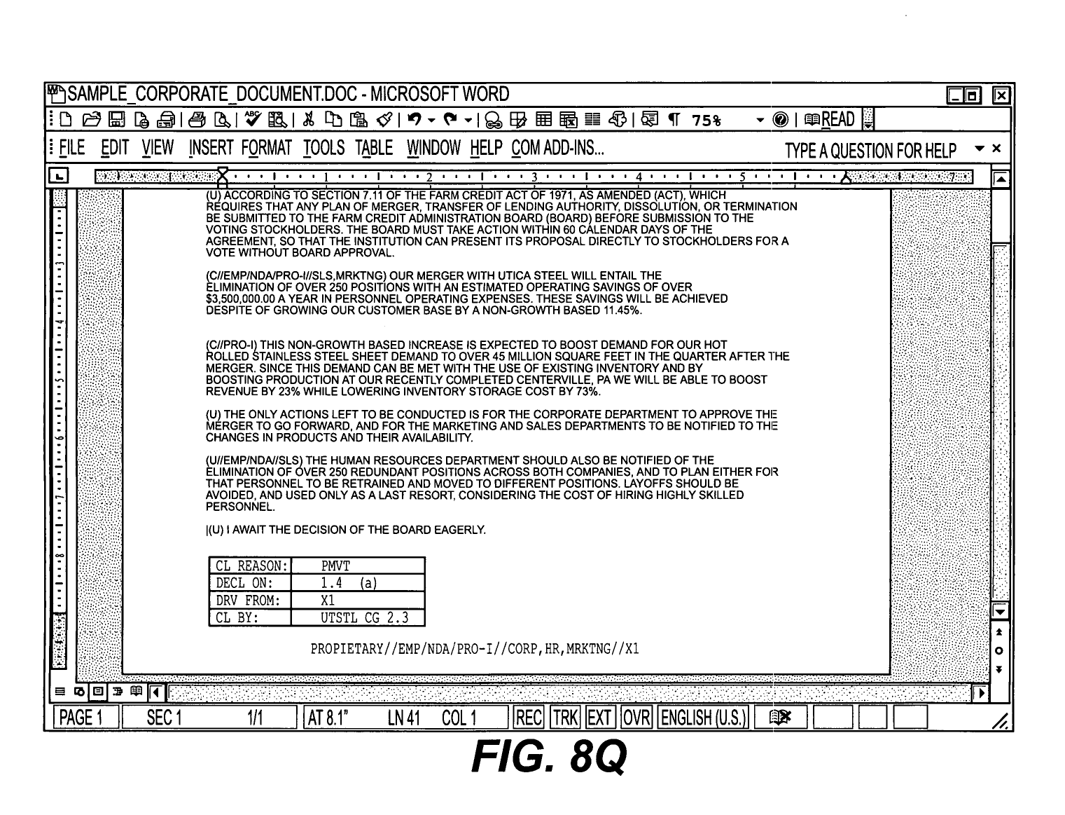

FIGS. 8A-8Q illustrate application of the portion marking process to a document 310 using the PMVT 400 of FIG. 6. The document 310 relates to a hypothetical merger with Utica Steel, and the information in the document 310 is sensitive. As a consequence, the document 310 needs to be marked so that the document 310 can be controlled properly. FIG. 8A shows portions of the document as displayed on a GUI 500. An exemplary fragment of the analysis rules used for marking the document 310 are shown in FIG. 7.

Using these analysis rules, and appropriate document division rules, the analysis engine completes a search and analysis of the document 310 to determine which rules apply to each of the documents portions. The results of the search and analysis are applied to the consequence resolution module 450 for a determination of the proper classification level, access control caveat(s), dissemination handling control caveat(s) for each of the documents portions.

FIG. 8B shows a pop-up window 505 in the GUI 500 that allows a user to invoke a current version of the PMVT 400 from a tools menu. FIG. 8C displays a window 510 that requires the reviewer to choose the fact that the operator/reviewer retains ultimate responsibility for marking the document 310, and that the software manufacturer bears no responsibility for such marking.

FIG. 8D shows a window 515 that provides the Reviewer 26 with rule sets from which to operate the PMVT 400. FIG. 8E illustrates a window 520 that allows the reviewer 26 to choose to make certain implied terms 522 ubiquitous, basically assuming that every portion of the document 310 contains those terms.

FIG. 8F illustrates the document 310 in the GUI 500 with a first portion 501 highlighted. Portion verification window 525 does not show any “hits,” indicating that the first portion 501 should not be classified or contain any access or dissemination or handling limitations. FIG. 8G shows the GUI 500, where the Reviewer 26 has elected to change the status of the first portion 501 from UNK (Unknown) to another classification by right clicking and selecting the “New” button 526. The result of selecting the “New” button 526 is shown in FIG. 8H, wherein window 530 is shown. Window 530 displays the highlighted portion to be changed in display 534, and provides check-the-box columns for classification level 531, access controls 532, and dissemination controls 533. The classification, for example, can be changed to one of “proprietary,” “private,” or “confidential”. FIG. 81 shows that the Reviewer 26 has chosen to change the marking of the first portion 501 to “proprietary classification;” “non-disclosure agreement” and “proprietary level I” for access controls, and “corporate” for dissemination control. FIG. 8J shows in portion verification 525 the marks that the PMVT 400 will apply to the first portion 501. The portion verification 525 includes apply button 537, which the reviewer 26 selects to have the PMVT 400 apply the displayed portion marking.

FIG. 8K shows the document 310 as displayed on the GUI 500 after the reviewer has elected to apply the displayed markings to the first portion 501. As can be seen, the first portion 501 is now marked (PROPIN//NDA/PRO-I//NK). In addition, the review/modify module 460 is now highlighting a second portion 502 of the document 310, and the portion verification 525 again shows no “hits.”

As the review process continues, some portions, such as portion, shown in FIG. 8L has multiple “hits,” as can be seen in the portion verification 525. In fact, the portion verification 525 show three “hits” for portion 506. Each such “hit” lists the rule, classification, access, and dissemination criteria that apply.

To see what word or words that caused a hit, and the associated rule, the Reviewer 26 selects a rule, and the word or words is highlighted, as shown in FIG. 8M. In FIG. 8M, the rule HCG 1.1, 1.2 is selected in the display of the portion verification 525, and the words “merger” and “Utica Steel” are highlighted in 506.

The review/modify module 460 allows the reviewer 26 want to change the results of a rule, as shown in FIG. 8N. In FIG. 8N, the reviewer has selected the third displayed rule, and has “right clicked” to cause pop-up menu 540 to be displayed. The Reviewer 26 can then select “Edit” from the pop-up menu 540. When “Edit” is selected, an edit window 545 is displayed, as shown in FIG. 80. The edit window 545 shows the current selections for classification, access, and dissemination, and displays the rule that results in these selections. Using the edit window 545, the Reviewer 26 can accept the selections, or change one or more of the selections. The rule hit window 545 also shows the information element from the standards that caused the rule hit to occur. This information element is commonly referred to as a “fact of” statement and is part of the rule set as shown in FIG. 7, 414.

Once all the document portions are reviewed and marked, the reviewer can move to a roll-up process for marking each of the document's pages in a header or footer. FIG. 8P shows a header/footer marking window 550 that allows the reviewer to enter appropriate classification and declassification information into a header or footer. The document page, with all portions marked, and with the appropriate footer entry, is shown in FIG. 8Q.

The PMVT 400 also records the initial classification, access, and dissemination decisions made by the analysis engine 402, and any changes made by the Reviewer 26. The record of classification decisions provides an audit trail that can be reviewed later if needed to further verify the classification results, or for other purposes.

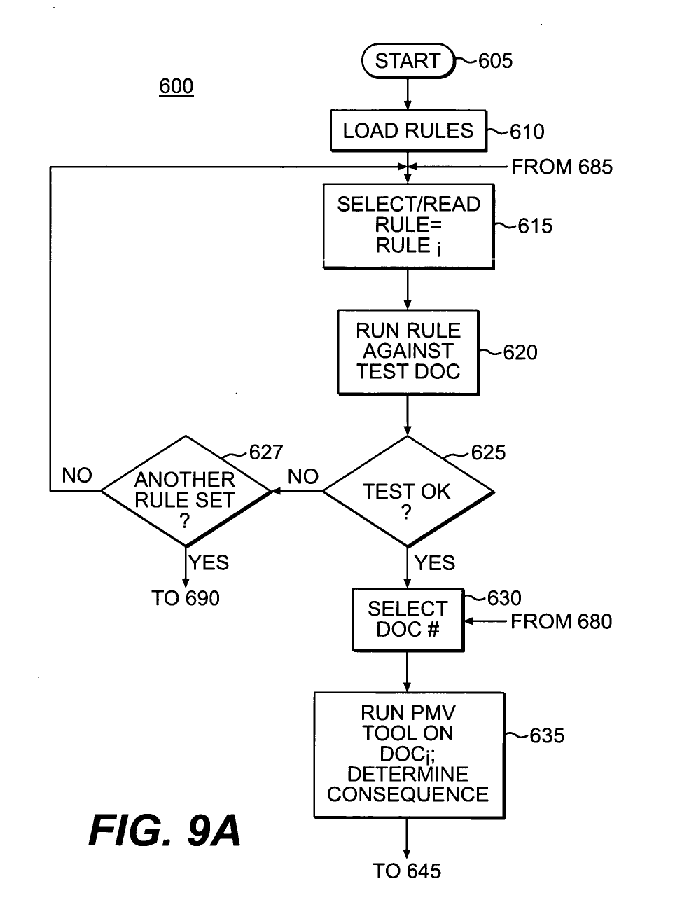

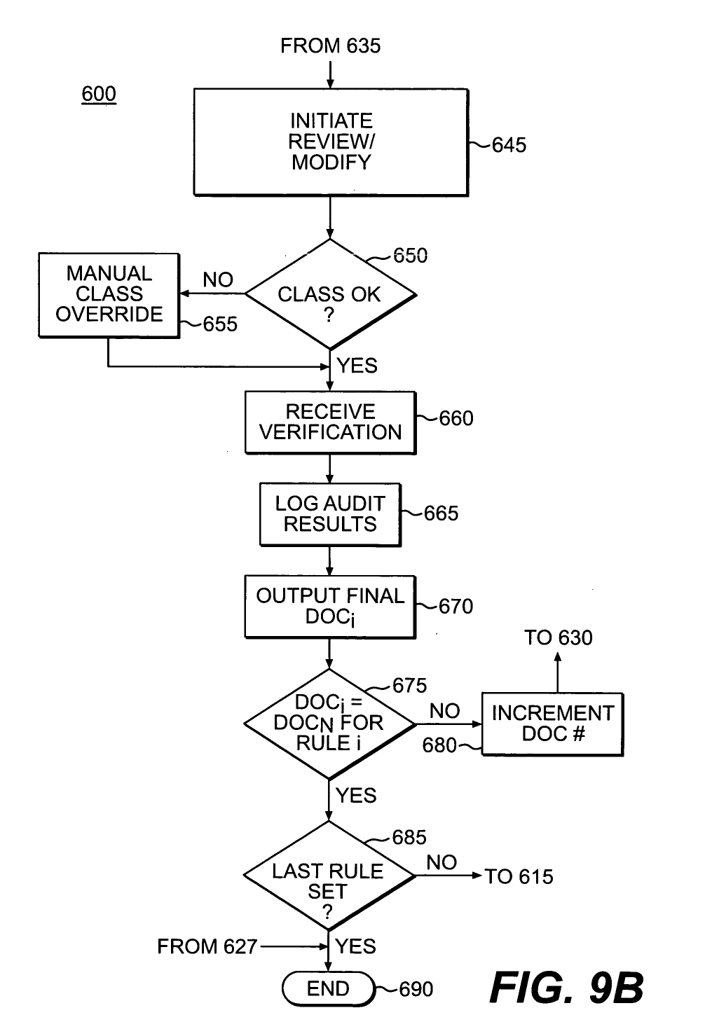

FIGS. 9A-9B are flowcharts illustrating an exemplary portion marking operation 600 of the PMVT 400. The operation 600 is executed in three distinct phases. As shown in FIGS. 9A and 9B, the first phase, loading, includes blocks 605 through 625. The second phase, document scanning, includes blocks 630 and 635. The third phase, verification, includes blocks 645 through 670. After the verification phase, the marked document is output.

The operation 600 begins with block 605. In block 610, a reviewer 26 site loads the analysis rules 412 into the analysis rules database 410. The Reviewer 26 can obtain the analysis rules from the customer 320, either over the Web 330, in digital format on some physical medium such as an optical disk, or in hard copy form, for example. With the analysis rules 412 loaded, the Reviewer 26 is ready to begin the phases of document scanning and portion marking and verification.

In block 615, the Reviewer 26 selects the appropriate rule set 412 from the database 410, and the rules are loaded into the analysis engine 402. In block 620, a test document having correct portion markings pre-determined is processed using the selected analysis rule set to verify proper operation of the PMVT 400. In an embodiment, the verification step of block 620 is omitted. The test document may be provided with each document or set of documents to be processed using a specific analysis rule set. Alternatively, the test document may be provided on a one-time basis, and the PMVT operation may be checked on a periodic basis using the provided test document and the appropriate analysis rule set. In block 625, the results of the test document processing are reviewed, either manually (i.e., the reviewer 26) or automatically by a processor associated with the PMVT 400. The result of the review determines whether an actual document is to be processed. If the test is completed satisfactorily, processing continues to block 630. If the test is not satisfactory, processing moves to block 627, and the reviewer is prompted to determine if the correct rule set has been selected. If the correct rule set was not selected, the operation 600 returns to block 615, and the correct rule set is selected. If the correct rule set was selected, the operation moves to block 690 and ends. In this case, the PMVT 400 is experiencing a malfunction, and a review of its operation is required.

In block 630, the reviewer selects a first document for processing by the PMVT 400 using the rule set selected in block 615, and loads the selected document into the analysis engine 402. The loaded document is copied in a secure maimer, thereby preserving the document in its original form. In block 635, the analysis engine 402 looks for instances of restricted words and phrases, determines the rule appropriate for any identified words and phrases, and determines the consequences appropriate for the determined rule. Block 635 continues until the entire document is portion marked, and the output 445 is provided to the review/modify module 460. The output 445 may be in .RTF format, for example. The output 445 may be displayed on the GUI 500, may be printed, or may be provided as an electronic file.

In block 645, the output 445 is displayed on the GUI 500 and the verification/modification review phase is initiated. The review proceeds on a portion-by-portion basis, or other basis, until all document portions are reviewed for correct classification. An audit program is optionally initiated by the PMVT 400 at the start of the review. The audit program records the consequences determined by the consequence resolution module 450, the markings made by the action engine 470, and any verifications or changes imposed by the Reviewer 26. In block 650, the PMVT 400 displays one or more portions of the document, and receives a command to highlight a first portion for review and verification. If the classification, access, and dissemination are correct (in the reviewer's opinion), then the PMVT 400 receives a verified signal, block 660, and the next document portion is reviewed. If any of the classification, access, and dissemination are not correct, the operation 600 moves to block 655, and the PMVT 400 receives a change command, such as increasing the classification level or adding an access restriction, for example. The operation 600 then returns to block 650 and the next document portion is reviewed. Note that when the Reviewer 26 changes a classification level, for example, the change may affect other portion markings. For example, if the reviewer increases the classification level of a paragraph from U to P, the document may also have its classification level changed. This process of changing classification levels (or access and dissemination) based on a manual override of the PMVT-determined consequences can ripple through the entire document. In such cases, document portions that had previously been verified, if changed, would become unverified, and would require a re-review and verification.

In block 665, the (optional) audit results are logged for future reference if needed. In block 670, the PMVT 400 outputs a final version of the document with all document portion bearing the appropriate markings. In block 675, the PMVT 400 prompts the Reviewer 26 to load a next original document for the selected classification rule set. If the previous document was the last document for this rule set (DOC₁=DOC_{N}), then Reviewer 26 will answer the prompt accordingly, and the operation 600 moves to block 685. If the previous document was not the last document to be reviewed, the operation 600 moves to block 680, and the document number is incremented. The operation 600 then returns to block 630, and the next document is loaded, scanned, and verified.

In block 685, the PMVT 400 prompts the Reviewer 26 to indicate if the selected rule set is the last rule set to apply to any documents. If the selected rule set is the last rule set, then the operation 600 moves to block 690 and ends. Otherwise, the operation 600 returns to block 615, and the Reviewer 26 selects the next rule set.

We claim:

1. A system for rules based content mining, analysis, and implementation of consequences, comprising:
a criteria search module that receives one original data set comprising data, wherein the criteria search module searches the data based on a selected analysis rule set and produces an output;
a data division module that divides the data into logical portions;
a rule implementation module that determines a rule that applies to each of the one or more data portions based on the output of the criteria search module; and
consequence resolution module that determines consequences for the data based on the output of the determined rule.

2. The system of claim 1, further comprising a review/modify module, the review/modify module enabling a verification of a consequence provided by the consequence resolution module, the review/modify module, comprising:
a display that presents the modified data for review, wherein the display comprises:
a status area that shows a status for each portion of the original data set,
an area that that displays the data portion of the original data set, and
means for allowing a reviewer to verify or change the consequence; and
an audit program that records each consequence change and implementation of the consequences.

3. The system of claim 2, further comprising an output module that provides consequence applied data to an outputted version of the data after the verification process is complete.

4. The system of claim 3, wherein the outputted version of the data is provided in a same format as the original data.

5. The system of claim 3, wherein the outputted version of the data is provided in an electronic format.

6. The system claim 1, wherein the system is provided at a centralized location and the original data is received at the centralized location from remote sites.

7. The system of claim 6, wherein the original data set is received at the centralized location over a network connection.

8. The system of claim 7, wherein the original data set is received at the centralized location on a computer-readable medium.

9. The system of claim 1, further comprising an analysis rules repository, wherein the repository includes one or more analysis rule sets useable for consequence implementation of a data set.

10. The system of claim 1, further comprising a portal to a Web-based analysis rules repository, wherein the Web-based analysis rules repository includes one or more analysis rule sets for consequence implementation of a data set.

11. The system of claim 1, wherein the analysis rule set comprises:
a section of terms;
a flag section comprising Boolean combinations of the terms; and
a rule section that defines different forms of consequences, based on one or more of the Boolean combinations and the terms and flags.

12. The system of claim 1, further comprising a test document feature, wherein the test document feature uses the analysis rule set and a known good document to verify proper implementation of consequences to the original data set.

13. The system of claim 1, wherein the criteria search module comprises a tree search algorithm.

14. A method, executed on a general purpose computer, for content mining, analysis, and consequence implementation of an original data set, comprising:
selecting an analysis rule set consequence implementation of the original data set;
searching the original data set for occurrences of key data, collections of data, and relationships among data, wherein the original data comprises one or more data divisions, and wherein the search is first completed for each data portion; and
automatically applying consequences to the data portions based on results of the search, wherein a consequence is first completed on one data portion, and the consequence of lower hierarchical level data portions is aggregated to a next higher hierarchical level data portion.

15. The method of claim 14, further comprising:
outputting a consequence applied version of the original data for review and verification;
verifying the output, comprising:
reviewing each data portion for a correct consequence implementation, and
verifying the consequence implementation, or changing the consequences.

16. The method of claim 14, further comprising loading the analysis rule set into an analysis rules repository.

17. The method of claim 14, wherein analysis rules are posted on a network resource, and wherein selecting the analysis rule set comprises accessing the network resource.

18. The method of claim 14, further comprising running a test to verify proper consequence implementation of the original data set.

19. The method of claim 14, further comprising outputting a final version of the original data, wherein data portions of the final version are annotated with consequence markings.

20. A portion marking and verification tool, comprising:
an analysis engine that receives an analysis rule set according to an original document to be portion marked;
a criteria search module that receives and electronic version of the document to be portion marked, wherein the criteria search module searches the document based on a selected analysis rule set and produces an output;
a document division module that divides the original document into one or more portions;
a rule action engine that determines a rule that applies to each of the one or more portions based on the output of the criteria search module; and
an consequence resolution module that determines portion markings for each of the one or more document portions based on the output of the determined rule.

21. The portion marking and verification tool of claim 20, further comprising a review/modify module, the review/modify module enabling a verification of the marks provided by the consequence resolution module, the review/modify module, comprising:
a display that present the portion-marked document for review, wherein the display comprises:
a status area that shows a status for each portion of the document,
a text area that that displays the portion-marked portions of the document, and
a window that allows a reviewer to verify or change the marks; and
a audit program that records each verification or change in the marks.

22. The portion marking and verification tool of claim 21, further comprising an output module that provides a portion-marked final version of the document after the verification is complete.

23. The portion marking and verification tool of claim 22, wherein the final version of the document is provided in a same format as the original document.

24. The portion marking and verification tool of claim 22, wherein the final version of the document is provided in an electronic format.

25. The portion marking and verification tool of claim 20, wherein the portion marking and verification tool is provided at a central location and the original document is received at the central location from a remote site.

26. The portion marking and verification tool of claim 25, wherein the original document is received at the central location over the Internet.

27. The portion marking and verification tool of claim 26, wherein the original document is received at the central location on a computer-readable medium.

28. The portion marking and verification tool of claim 20, further comprising an analysis rules database, wherein the database includes one or more classification rule sets useable for portion marking a document.

29. The portion marking and verification tool of claim 20, further comprising a portal to a Web-based classification rules database, wherein the Web-based analysis rules database includes one or more analysis rule sets for portion marking a document.

30. The portion marking and verification tool of claim 20, wherein the analysis rule set comprises:
a section of terms;
a flag section comprising Boolean combinations of the terms; and
a rule section that defines classification, access, and dissemination rules based on one or more of the Boolean combinations and the terms.

31. The portion marking and verification tool of claim 20, further comprising a test document feature, wherein the test document feature uses the rule set and a known good document to verify proper portion marking by the automatic portion marking tool.

32. The portion marking and verification tool of claim 20, wherein the criteria search module comprises a tree search algorithm.

33. A method, executed on a general purpose computer, for portion and marking and verifying an original document, comprising:
selecting a classification rule set for marking the original document;
searching the original document for occurrences of restricted words, phrases and relationships among words and phrases, wherein the original document comprises one or more portions, and wherein the search is first completed for each document portion; and
automatically marking the document portions based on results of the search, wherein the marking is first completed on one document portion, and the markings of lower hierarchical level document portions are aggregated to a next higher hierarchical level document portion.

34. The method of claim 33, further comprising:
outputting a portion-marked version of the original document for review and verification;
verifying the output, comprising:
reviewing each document portion for a correct annotation, and
verifying the annotation, or changing the annotation.

35. The method of claim 34, wherein changing the annotation comprises:
increasing the classification level, access control caveat(s), and dissemination control handling caveat(s);
decreasing the classification level, access control caveat(s), and dissemination control handling caveat(s);
adding to the classification level, access control caveat(s), and dissemination control handling caveat(s).

36. The method of claim 33, further comprising loading an analysis rule set into an analysis rules database.

37. The method of claim 33, wherein analysis rules are posted on an Internet Web site, and wherein selecting the analysis rule set comprises accessing the Web site.

38. The method of claim 33, further comprising running a test to verify proper portion marking of the original document.

39. The method of claim 33, further comprising outputting a final version of the original document, wherein document portions of the final version are annotated with a classification level, access control caveat(s), and dissemination control handling caveat(s).
